(19) United States
(12) Patent Application Publication
(10) Pub. No.: US 2026/0262636 A1
(43) Pub. Date: Sep. 10, 2026

(54) ISOMERIC COMPOSTIONS, METHODS OF USE THEREOF, AND PROCESESSES FOR PREPARATION THEREOF

(71) Applicant: BEDOUKIANRESEARCH, INC., Danbury, CT (US)

(72) Inventors: Vincent James Chebny, Tulsa, OK (US); David Zareh Bedoukian, Danbury, CT (US); Rodrigo Oliveira da Silva, Bethal, CT (US); Marie Maher, Bethel, CT (US)

(73) Assignee: BEDOUKIANRESEARCH, INC., Danbury, CT (US)

(21) Appl. No.: 19/556,090

(22) Filed: Mar. 4, 2026

Related U.S. Application Data
(60) Provisional application No. 63/766,657, filed on Mar. 4, 2025.

(51) Int. Cl. A01N 37/02; A01P 7/04

(52) U.S. Cl. CPC A01N 37/02; A01P 7/04

(57) ABSTRACT

A composition having at least one isomeric alkatrienyl ester in an amount effective to attract moths of the genus Conopomorpha, e.g., male cocoa pod borer Conopomorpha cramerella, and processes for preparation thereof. A method of attracting, monitoring, or controlling moths of the genus Conopomorpha or male cocoa pod borer Conopomorpha cramerella by treating an object or area with an effective amount of the composition, or exposing the moths of the genus Conopomorpha or cocoa pod borer Conopomorpha cramerella to an effective amount of the composition. A trap configured for capturing moths of the genus Conopomorpha, the trap having a lure with the composition on the surface thereof or impregnated therein. A substrate having the composition on a surface or impregnated therein.

### RELATED APPLICATION

This application claims the benefit of copending U.S. Application No. 63/766,657, filed Mar. 4, 2025, which is incorporated herein by reference in its entirety.

### BACKGROUND OF THE DISCLOSURE

### 1. Field of the Disclosure

This disclosure relates to isomeric compositions, including synergistic isomeric compositions, methods of attracting, monitoring, and controlling moths of the genus Conopomorpha, including cocoa pod borer Conopomorpha cramerella, using the isomeric compositions, and processes for preparing the isomeric compositions.

### 2. Description of the Related Art

The cocoa pod borer (CPB) Conopomorpha cramerella (Snellen) (Lepidoptera: Gracillariidae) is a moth species endemic to Southeast Asia. The CPB is one of the most serious pests of cacao grown in Southeast Asia. The CPB lays eggs on the surfaces of cocoa pods. The hatched larvae penetrate to the pod interior and feed on the pulp, thereby reducing cacao bean yield and quality.

The CPB has become a pest of increasing economic importance for the cocoa industry in Southeast Asia, particularly Indonesia, the Philippines, Malaysia, and Papua New Guinea. The CPB's destructive impact on cocoa farms is responsible in large part for the serious decline in Southeast Asia cocoa production.

Several control measures have been implemented to combat CPB infestation with limited success. Biological control measures have been found to have minimal impact. Parasitoids and entomopathogens have been found to not provide enough efficacy or not economically viable. Preventing CPB oviposition on cocoa pods has been achieved successfully by covering the fruits with plastic bags, or sleeves, but this method is labor intensive. A complete and synchronic harvesting of mature pods has been found to reduce pest populations, but only temporarily due to reintroductions from neighboring farms or from alternative hosts.

At present, the most effective method for control of CPB is the use of pesticides, but the cost/efficiency ratio remains poor due to the CPB life cycle (i.e., the larval stages are protected within the pod and not exposed to topical pesticides). The pesticide applications are not sustainable from an environmental and financial perspective. More sustainable control methods for CPB need to be developed due to increasing concerns about pesticide residues in chocolate.

Due to the adverse effects of pesticides on the environment and human health, there is a demand for the development of new eco-friendly and safe pest control technology, such as mating disruption and mass trapping using insect sex pheromones.

The CPB pheromone composition has been identified as a blend of 4 components, namely (E,Z,Z)- and (E,E,Z)-4,6,10-hexadecatrienyl acetates and the corresponding alcohols in a ratio of 40:60:4:6. Geometric isomers of the (E,Z,Z)- and (E,E,Z)-4,6,10-hexadecatrienyl acetates and the corresponding alcohols have been found to not affect attractancy of CPB in cocoa plantations. See W. Vanhove et al., Geometric Isomers of Sex Pheromone Components Do Not Affect Attractancy of Conopomorpha cramerella in Cocoa Plantations, J. Appl. Entomol. 39 (2015 ) 660-668 Published 2015. In tests conducted in a cocoa field using Delta traps, male captures were not significantly different among traps baited with pheromone blends containing, in addition to the components of the CPB pheromone composition, other geometric acetates and corresponding alcohols, namely (E,Z,E)-, (Z,Z,Z)-, (Z,E,Z)-, and (Z,E,E)-4,6,10-hexadecatrienyl acetates and the corresponding alcohols. The testing indicated that the CPB males did not discriminate among components of the CPB pheromone composition and other geometric isomers in the blends. Neither antagonistic nor synergistic effects from the other geometric isomers were observed in the testing.

There is a need for a composition that is safe for humans, animals and the environment that can be used to effectively attract, control, and/or monitor CPB, and for safe and effective means (e.g., mass trapping) to employ such compositions.

The present disclosure provides many advantages, which shall become apparent as described below.

### SUMMARY OF THE DISCLOSURE

This disclosure relates to isomeric compositions, including synergistic isomeric compositions, methods of attracting, monitoring, and controlling moths of the genus Conopomorpha, including cocoa pod borer Conopomorpha cramerella, using the isomeric compositions, and processes for preparing the isomeric compositions.

This disclosure relates in part to compositions having: at least one isomeric alkatrienyl ester in an amount effective to attract moths of the genus Conopomorpha or cocoa pod borer Conopomorpha cramerella; or at least one isomeric alkatrienyl alcohol in an amount effective to attract moths of the genus Conopomorpha or cocoa pod borer Conopomorpha cramerella; or a combination of at least one isomeric alkatrienyl ester and at least one isomeric alkatrienyl alcohol in an amount effective to attract moths of the genus Conopomorpha or male cocoa pod borer Conopomorpha cramerella. Attraction of moths of the genus Conopomorpha or cocoa pod borer Conopomorpha cramerella is improved as compared to attraction of moths of the genus Conopomorpha or male cocoa pod borer Conopomorpha cramerella with a composition other than the composition.

This disclosure also relates in part to synergistic compositions having at least two isomeric alkatrienyl esters in an amount effective to attract moths of the genus Conopomorpha or cocoa pod borer Conopomorpha cramerella; or at least two isomeric alkatrienyl alcohols in an amount effective to attract moths of the genus Conopomorpha or cocoa pod borer Conopomorpha cramerella; or a combination of at least one isomeric alkatrienyl ester and at least one isomeric alkatrienyl alcohol in an amount effective to attract moths of the genus Conopomorpha or male cocoa pod borer Conopomorpha cramerella. The synergistic compositions produce, when the moths of the genus Conopomorpha or cocoa pod borer Conopomorpha cramerella are exposed to the synergistic composition, a combined attractancy effect greater than the sum of the separate attractancy effects from the separate isomeric components of said composition, at comparable concentrations.

This disclosure further relates in part to a method of attracting moths of the genus Conopomorpha or male cocoa pod borer Conopomorpha cramerella. The method involves treating an object or area with a composition of this disclosure, or a synergistic composition of this disclosure, in an amount effective to attract moths of the genus Conopomorpha or male cocoa pod borer Conopomorpha cramerella.

This disclosure yet further relates in part to a method of monitoring moths of the genus Conopomorpha or cocoa pod borer Conopomorpha cramerella in an area. The method involves: providing a trap having a lure, wherein the lure comprises the composition of this disclosure, or the synergistic composition of this disclosure, in an amount effective to attract moths of the genus Conopomorpha or male cocoa pod borer Conopomorpha cramerella; positioning the trap in the area; and observing moths of the genus Conopomorpha or cocoa pod borer Conopomorpha cramerella captures in the trap over a period of time.

This disclosure also relates in part to a method of controlling moths of the genus Conopomorpha or cocoa pod borer Conopomorpha cramerella. The method involves: exposing said moths of the genus Conopomorpha or cocoa pod borer Conopomorpha cramerella to an effective amount of the composition of this disclosure, or the synergistic composition of this disclosure.

This disclosure further relates in part to a trap configured for capturing moths of the genus Conopomorpha or cocoa pod borer Conopomorpha cramerella. The trap has a lure, and the lure includes the composition of this disclosure, or the synergistic composition of this disclosure, in an amount effective to attract moths of the genus Conopomorpha or male cocoa pod borer Conopomorpha cramerella.

This disclosure yet further relates in part to a substrate having the composition of this disclosure, or the synergistic composition of this disclosure, on a surface or impregnated therein, in an amount effective to attract moths of the genus Conopomorpha or male cocoa pod borer Conopomorpha cramerella.

This disclosure also relates in part to processes for preparing the composition of this disclosure, or the synergistic composition of this disclosure. One process involves: providing at least one isomeric alkatrienyl ester; and blending the at least one isomeric alkatrienyl ester and optional ingredients in an amount effective to attract moths of the genus Conopomorpha or cocoa pod borer Conopomorpha cramerella.

Another process of this disclosure involves: providing at least one isomeric alkatrienyl alcohol; and blending the at least one isomeric alkatrienyl alcohol and optional ingredients in an amount effective to attract moths of the genus Conopomorpha or cocoa pod borer Conopomorpha cramerella.

Still another process of this disclosure involves: providing at least one isomeric alkatrienyl ester; providing at least one isomeric alkatrienyl alcohol; and blending the at least one isomeric alkatrienyl ester and the at least one isomeric alkatrienyl alcohol in an amount effective to attract moths of the genus Conopomorpha or male cocoa pod borer Conopomorpha cramerella.

This disclosure further relates to a process for preparing the composition of this disclosure, or the synergistic composition of this disclosure. The process involves: providing a synthetic pheromone of cocoa pod borer Conopomorpha cramerella impregnated in, or on a surface of, a substrate; and subjecting the synthetic pheromone and substrate to reaction conditions sufficient to form the composition of this disclosure, or the synergistic composition of this disclosure.

This disclosure still further relates to a process for preparing the composition of this disclosure, or the synergistic composition of this disclosure. The process involves: providing a synthetic pheromone of cocoa pod borer Conopomorpha cramerella; and reacting the synthetic pheromone in the presence of a catalyst (e.g., sulfur or a thiol) and under reaction conditions sufficient to form the composition of this disclosure, or the synergistic composition of this disclosure, before or after inclusion in a controlled release formulation.

This disclosure includes optical isomers, diastereomers and enantiomers of alkatrienyl esters and alkatrienyl alcohols. Thus, at all stereocenters where stereochemistry is not explicitly defined, all possible epimers are envisioned.

Further objects, features and advantages of the present disclosure will be understood by reference to the following detailed description.

### DESCRIPTION OF THE EMBODIMENTS

Disclosed herein are isomeric compositions, including synergistic isomeric compositions, in an amount effective to attract moths of the genus Conopomorpha or male cocoa pod borer Conopomorpha cramerella. Also disclosed herein are methods of attracting, monitoring, and/or controlling moths of the genus Conopomorpha or cocoa pod borer Conopomorpha cramerella using the isomeric compositions and/or synergistic isomeric compositions, in an amount effective to attract moths of the genus Conopomorpha or male cocoa pod borer Conopomorpha cramerella. Further disclosed herein are processes for preparing the isomeric compositions.

### Moths of the Genus Conopomorpha

The compositions, methods, and processes of this disclosure all involve attractancy of moths of the genus Conopomorpha, in particular, male cocoa pod borer Conopomorpha cramerella. Conopomorpha is a genus of moths in the family Gracillariidae, order Lepidoptera.

Illustrative moths of the genus Conopomorpha include, for example, Conopomorpha cramerella, Conopomorpha sinensis, Conopomorpha antimacha, Conopomorpha chionochtha, Conopomorpha chionosema, Conopomorpha cyanospila, Conopomorpha euphanes, Conopomorpha flueggella, Conopomorpha fustigera, Conopomorpha habrodes, Conopomorpha heliopla, Conopomorpha litchiella, Conopomorpha oceanica, and Conopomorpha zaplaca.

In accordance with this disclosure, preferred moths of the genus Conopomorpha include Conopomorpha cramerella and Conopomorpha sinensis, particularly the male cocoa pod borer Conopomorpha cramerella.

### Compositions

The compositions of this disclosure are moths of the genus Conopomorpha or male cocoa pod borer Conopomorpha cramerella attractants having at least one isomeric alkatrienyl esters and at least one isomeric alkatrienyl alcohol in an amount effective to attract moths of the genus Conopomorpha or male cocoa pod borer Conopomorpha cramerella. With the compositions of this disclosure, attraction of moths of the genus Conopomorpha or male cocoa pod borer Conopomorpha cramerella is improved greater than about 10%, or greater than about 20%, or greater than about 30%, or greater than about 40%, or greater than about 50%, or greater than about 60%, or greater than about 70%, or greater than about 80%, or greater than about 90%, as compared to attraction of moths of the genus Conopomorpha or male cocoa pod borer Conopomorpha cramerella with a composition other than the composition of this disclosure.

In the compositions of this disclosure, the at least one isomeric alkatrienyl ester, or the at least one isomeric alkatrienyl alcohol, or the combination of the at least one isomeric alkatrienyl ester and at least one isomeric alkatrienyl alcohol, each comprise a carbon backbone having from about 14 to about 18 carbon atoms, and from about two to about four unsaturated double bonds positioned on the carbon backbone. The unsaturated double bonds are conjugated or unconjugated, and have an isomer configuration of cis, trans, or a combination or cis and trans.

The compositions of this disclosure comprise at least one isomeric alkatrienyl ester, or at least one isomeric alkatrienyl alcohol, or a combination of at least one isomeric alkatrienyl ester and at least one isomeric alkatrienyl alcohol, each in an amount effective to attract moths of the genus Conopomorpha or male cocoa pod borer Conopomorpha cramerella. Attraction of moths of the genus Conopomorpha or male cocoa pod borer Conopomorpha cramerella is improved as compared to attraction of moths of the genus Conopomorpha or male cocoa pod borer Conopomorpha cramerella with a composition other than the composition of this disclosure.

The compositions of this disclosure include, alone or in combination with the at least one or more isomeric alkatrienyl alcohols: at least one isomeric alkatrienyl ester; or at least two isomeric alkatrienyl esters; or at least three isomeric alkatrienyl esters; or at least four isomeric alkatrienyl esters; or at least five isomeric alkatrienyl esters; or at least six isomeric alkatrienyl esters; or at least seven isomeric alkatrienyl esters; or at least eight isomeric alkatrienyl esters.

The compositions of this disclosure include, alone or in combination with the at least one or more isomeric alkatrienyl esters: at least one isomeric alkatrienyl alcohol; or at least two isomeric alkatrienyl alcohols; or at least three isomeric alkatrienyl alcohols; or at least four isomeric alkatrienyl alcohols; or at least five isomeric alkatrienyl alcohols; or at least six isomeric alkatrienyl alcohols; or at least seven isomeric alkatrienyl alcohols; or at least eight isomeric alkatrienyl alcohols.

In an embodiment, the compositions of this disclosure include at least one isomeric alkatrienyl ester and at least one isomeric alkatrienyl alcohol; or at least one isomeric alkatrienyl ester and at least two isomeric alkatrienyl alcohols; or at least one isomeric alkatrienyl ester and at least three isomeric alkatrienyl alcohols; or at least one isomeric alkatrienyl ester and at least four isomeric alkatrienyl alcohols; or at least one isomeric alkatrienyl ester and at least five isomeric alkatrienyl alcohols; or at least one isomeric alkatrienyl ester and at least six isomeric alkatrienyl alcohols; or at least one isomeric alkatrienyl ester and at least seven isomeric alkatrienyl alcohols; or at least one isomeric alkatrienyl ester and at least eight isomeric alkatrienyl alcohols.

In an embodiment, the compositions of this disclosure include at least two isomeric alkatrienyl esters and at least one isomeric alkatrienyl alcohol; or at least two isomeric alkatrienyl esters and at least two isomeric alkatrienyl alcohols; or at least two isomeric alkatrienyl esters and at least three isomeric alkatrienyl alcohols; or at least two isomeric alkatrienyl esters and at least four isomeric alkatrienyl alcohols; or at least two isomeric alkatrienyl esters and at least five isomeric alkatrienyl alcohols; or at least two isomeric alkatrienyl esters and at least six isomeric alkatrienyl alcohols; or at least two isomeric alkatrienyl esters and at least seven isomeric alkatrienyl alcohols; or at least two isomeric alkatrienyl esters and at least eight isomeric alkatrienyl alcohols.

In an embodiment, the compositions of this disclosure include at least three isomeric alkatrienyl esters and at least one isomeric alkatrienyl alcohol; or at least three isomeric alkatrienyl esters and at least two isomeric alkatrienyl alcohols; or at least three isomeric alkatrienyl esters and at least three isomeric alkatrienyl alcohols; or at least three isomeric alkatrienyl esters and at least four isomeric alkatrienyl alcohols; or at least three isomeric alkatrienyl esters and at least five isomeric alkatrienyl alcohols; or at least three isomeric alkatrienyl esters and at least six isomeric alkatrienyl alcohols; or at least three isomeric alkatrienyl esters and at least seven isomeric alkatrienyl alcohols; or at least three isomeric alkatrienyl esters and at least eight isomeric alkatrienyl alcohols.

In an embodiment, the compositions of this disclosure include at least four isomeric alkatrienyl esters and at least one isomeric alkatrienyl alcohol; or at least four isomeric alkatrienyl esters and at least two isomeric alkatrienyl alcohols; or at least four isomeric alkatrienyl esters and at least three isomeric alkatrienyl alcohols; or at least four isomeric alkatrienyl esters and at least four isomeric alkatrienyl alcohols; or at least four isomeric alkatrienyl esters and at least five isomeric alkatrienyl alcohols; or at least four isomeric alkatrienyl esters and at least six isomeric alkatrienyl alcohols; or at least four isomeric alkatrienyl esters and at least seven isomeric alkatrienyl alcohols; or at least four isomeric alkatrienyl esters and at least eight isomeric alkatrienyl alcohols.

In an embodiment, the compositions of this disclosure include at least five isomeric alkatrienyl esters and at least one isomeric alkatrienyl alcohol; or at least five isomeric alkatrienyl esters and at least two isomeric alkatrienyl alcohols; or at least five isomeric alkatrienyl esters and at least three isomeric alkatrienyl alcohols; or at least five isomeric alkatrienyl esters and at least four isomeric alkatrienyl alcohols; or at least five isomeric alkatrienyl esters and at least five isomeric alkatrienyl alcohols; or at least five isomeric alkatrienyl esters and at least six isomeric alkatrienyl alcohols; or at least five isomeric alkatrienyl esters and at least seven isomeric alkatrienyl alcohols; or at least five isomeric alkatrienyl esters and at least eight isomeric alkatrienyl alcohols.

In an embodiment, the compositions of this disclosure include at least six isomeric alkatrienyl esters and at least one isomeric alkatrienyl alcohol; or at least six isomeric alkatrienyl esters and at least two isomeric alkatrienyl alcohols; or at least six isomeric alkatrienyl esters and at least three isomeric alkatrienyl alcohols; or at least six isomeric alkatrienyl esters and at least four isomeric alkatrienyl alcohols; or at least six isomeric alkatrienyl esters and at least five isomeric alkatrienyl alcohols; or at least six isomeric alkatrienyl esters and at least six isomeric alkatrienyl alcohols; or at least six isomeric alkatrienyl esters and at least seven isomeric alkatrienyl alcohols; or at least six isomeric alkatrienyl esters and at least eight isomeric alkatrienyl alcohols.

In an embodiment, the compositions of this disclosure include at least seven isomeric alkatrienyl esters and at least one isomeric alkatrienyl alcohol; or at least seven isomeric alkatrienyl esters and at least two isomeric alkatrienyl alcohols; or at least seven isomeric alkatrienyl esters and at least three isomeric alkatrienyl alcohols; or at least seven isomeric alkatrienyl esters and at least four isomeric alkatrienyl alcohols; or at least seven isomeric alkatrienyl esters and at least five isomeric alkatrienyl alcohols; or at least seven isomeric alkatrienyl esters and at least six isomeric alkatrienyl alcohols; or at least seven isomeric alkatrienyl esters and at least seven isomeric alkatrienyl alcohols; or at least seven isomeric alkatrienyl esters and at least eight isomeric alkatrienyl alcohols.

In an embodiment, the compositions of this disclosure include at least eight isomeric alkatrienyl esters and at least one isomeric alkatrienyl alcohol; or at least eight isomeric alkatrienyl esters and at least two isomeric alkatrienyl alcohols; or at least eight isomeric alkatrienyl esters and at least three isomeric alkatrienyl alcohols; or at least eight isomeric alkatrienyl esters and at least four isomeric alkatrienyl alcohols; or at least eight isomeric alkatrienyl esters and at least five isomeric alkatrienyl alcohols; or at least eight isomeric alkatrienyl esters and at least six isomeric alkatrienyl alcohols; or at least eight isomeric alkatrienyl esters and at least seven isomeric alkatrienyl alcohols; or at least eight isomeric alkatrienyl esters and at least eight isomeric alkatrienyl alcohols.

In accordance with this disclosure, the at least one isomeric alkatrienyl ester, or the at least two isomeric alkatrienyl esters; or the at least three isomeric alkatrienyl esters; or the at least four isomeric alkatrienyl esters; or the at least five isomeric alkatrienyl esters; or the at least six isomeric alkatrienyl esters; or the at least seven isomeric alkatrienyl esters; or the at least eight isomeric alkatrienyl esters, are selected from (E,E,E)-4,6,10-hexadecatrienyl acetate, (E,E,Z)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, (Z,E,Z)-4,6,10-hexadecatrienyl acetate, and (E,Z,Z)-4,6,10-hexadecatrienyl acetate.

In accordance with this disclosure, the at least one isomeric alkatrienyl alcohol, or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols, are selected from (E,E,E)-4,6,10-hexadecatrienol, (E,E,Z)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, (Z,E,Z)-4,6,10-hexadecatrienol, and (E,Z,Z)-4,6,10-hexadecatrienol.

In an embodiment, the at least one isomeric alkatrienyl ester is selected from (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols, is selected from (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.

In an embodiment, the at least two isomeric alkatrienyl esters are selected from (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.

In an embodiment, the at least three isomeric alkatrienyl esters are selected from (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.

In an embodiment, the at least four isomeric alkatrienyl esters are selected from (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.

In an embodiment, the at least five isomeric alkatrienyl esters are selected from (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.

In an embodiment, the at least six isomeric alkatrienyl esters are selected from (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.

In an embodiment, the at least seven isomeric alkatrienyl esters are selected from (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.

In an embodiment, the at least eight isomeric alkatrienyl esters are selected from (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.

In an embodiment, the at least one isomeric alkatrienyl ester can include one or any combination of (E,E,Z)-4,6,10-hexadecatrienyl acetate, (E,Z,Z)-4,6,10-hexadecatrienyl acetate, and (Z,E,Z)-4,6,10-hexadecatrienyl acetate; and the at least one isomeric alkatrienyl alcohol can include one or any combination of (E,E,Z)-4,6,10-hexadecatrienol, (E,Z,Z)-4,6,10-hexadecatrienol, and (Z,E,Z)-4,6,10-hexadecatrienol.

In an embodiment, the at least one isomeric alkatrienyl ester can include one or any combination of (E,E,Z)-4,6,10-hexadecatrienyl acetate, (E,Z,Z)-4,6,10-hexadecatrienyl acetate, and another isomeric alkatrienyl ester; and the at least one isomeric alkatrienyl alcohol can include any one or combination of (E,E,Z)-4,6,10-hexadecatrienol, (E,Z,Z)-4,6,10-hexadecatrienol, and another isomeric alkatrienyl alcohol.

In an embodiment, the at least one isomeric alkatrienyl ester can include one or any combination of (E,E,Z)-4,6,10-hexadecatrienyl acetate, (E,Z,Z)-4,6,10-hexadecatrienyl acetate, (Z,E,Z)-4,6,10-hexadecatrienyl acetate, and another isomeric alkatrienyl ester; and the at least one isomeric alkatrienyl alcohol can include any one or combination of (E,E,Z)-4,6,10-hexadecatrienol, (E,Z,Z)-4,6,10-hexadecatrienol, (Z,E,Z)-4,6,10-hexadecatrienol, and another isomeric alkatrienyl alcohol.

The compositions of this disclosure can include at least one isomeric alkatrienyl ester selected from (E,E,Z)-4,6,10-hexadecatrienyl acetate, (E,Z,Z)-4,6,10-hexadecatrienyl acetate, and (Z,E,Z)-4,6,10-hexadecatrienyl acetate; alone or in combination with at least one or more isomeric alkatrienyl alcohols.

The compositions of this disclosure can include at least one isomeric alkatrienyl alcohol selected from (E,E,Z)-4,6,10-hexadecatrienol, (E,Z,Z)-4,6,10-hexadecatrienol, and (Z,E,Z)-4,6,10-hexadecatrienol; alone or in combination with at least one or more isomeric alkatrienyl esters.

The compositions of this disclosure can include at least one isomeric alkatrienyl ester selected from (E,E,Z)-4,6,10-hexadecatrienyl acetate, (E,Z,Z)-4,6,10-hexadecatrienyl acetate, and another isomeric alkatrienyl ester; alone or in combination with at least one or more isomeric alkatrienyl alcohols.

The compositions of this disclosure can include at least one isomeric alkatrienyl alcohol selected from (E,E,Z)-4,6,10-hexadecatrienol, (E,Z,Z)-4,6,10-hexadecatrienol, and another isomeric alkatrienyl alcohol; alone or in combination with at least one or more isomeric alkatrienyl esters.

The compositions of this disclosure can include at least one isomeric alkatrienyl ester (E,E,Z)-4,selected from 6,10-hexadecatrienyl acetate, (E,Z,Z)-4,6,10-hexadecatrienyl acetate, (Z,E,Z)-4,6,10-hexadecatrienyl acetate, and another isomeric alkatrienyl ester; alone or in combination with at least one or more isomeric alkatrienyl alcohols.

The compositions of this disclosure can include at least one isomeric alkatrienyl alcohol selected from (E,E,Z)-4,6,10-hexadecatrienol, (E,Z,Z)-4,6,10-hexadecatrienol, (Z,E,Z)-4,6,10-hexadecatrienol, and another isomeric alkatrienyl alcohol; alone or in combination with at least one or more isomeric alkatrienyl esters.

In accordance with this disclosure, the at least one isomeric alkatrienyl ester, alone or in combination with the at least one isomeric alkatrienyl alcohol, has from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.

In accordance with this disclosure, the at least one isomeric alkatrienyl alcohol, alone or in combination with the at least one isomeric alkatrienyl ester, has from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.

In an embodiment of the compositions of this disclosure having a combination of at least one isomeric alkatrienyl ester and at least one isomeric alkatrienyl alcohol, the at least one isomeric alkatrienyl ester has from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols; have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.

In an embodiment of the compositions of this disclosure having a combination of at least one isomeric alkatrienyl ester and at least one isomeric alkatrienyl alcohol, the at least two isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols; have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.

In an embodiment of the compositions of this disclosure having a combination of at least one isomeric alkatrienyl ester and at least one isomeric alkatrienyl alcohol, the at least three isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols; have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.

In an embodiment of the compositions of this disclosure having a combination of at least one isomeric alkatrienyl ester and at least one isomeric alkatrienyl alcohol, the at least four isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols;, has from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.

In an embodiment of the compositions of this disclosure having a combination of at least one isomeric alkatrienyl ester and at least one isomeric alkatrienyl alcohol, the at least five isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols;, have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.

In an embodiment of the compositions of this disclosure having a combination of at least one isomeric alkatrienyl ester and at least one isomeric alkatrienyl alcohol, the at least six isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols, have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.

In an embodiment of the compositions of this disclosure having a combination of at least one isomeric alkatrienyl ester and at least one isomeric alkatrienyl alcohol, the at least seven isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols;, have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.

In an embodiment of the compositions of this disclosure having a combination of at least one isomeric alkatrienyl ester and at least one isomeric alkatrienyl alcohol, the at least eight isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition; and the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols;, have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.

The E,E,E isomeric alkatrienyl esters can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The E,E,Z isomeric alkatrienyl esters can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The E,Z,E isomeric alkatrienyl esters can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The Z,E,E isomeric alkatrienyl esters can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The Z,Z,Z isomeric alkatrienyl esters can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The Z,Z,E isomeric alkatrienyl esters can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The Z,E,Z isomeric alkatrienyl esters can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The E,Z,Z isomeric alkatrienyl esters can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The E,E,E isomeric alkatrienyl alcohols can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The E,E,Z isomeric alkatrienyl alcohols can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The E,Z,E isomeric alkatrienyl alcohols can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The Z,E,E isomeric alkatrienyl alcohols can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The Z,Z,Z isomeric alkatrienyl alcohols can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The Z,Z,E isomeric alkatrienyl alcohols can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The Z,E,Z isomeric alkatrienyl alcohols can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The E,Z,Z isomeric alkatrienyl alcohols can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the total isomers in the composition.

The isomeric alkatrienyl esters can be present in the compositions of this disclosure in an amount from about 0.1 weight percent to about 99.9 weight percent, or from about 0.1 weight percent to about 90 weight percent, or from about 0.1 weight percent to about 80 weight percent, or from about 0.1 weight percent to about 70 weight percent, or from about 0.1 weight percent to about 60 weight percent, or from about 0.1 weight percent to about 50 weight percent, or from about 0.1 weight percent to about 40 weight percent, or from about 0.1 weight percent to about 30 weight percent, or from about 0.1 weight percent to about 20 weight percent, or from about 0.1 weight percent to about 10 weight percent, or from about 0.1 weight percent to about 99.9 weight percent, or from about 10 weight percent to about 99.9 weight percent, or from about 20 weight percent to about 99.9 weight percent, or from about 30 weight percent to about 99.9 weight percent, or from about 40 weight percent to about 99.9 weight percent, or from about 50 weight percent to about 99.9 weight percent, or from about 60 weight percent to about 99.9 weight percent, or from about 70 weight percent to about 99.9 weight percent, or from about 80 weight percent to about 99.9 weight percent, or from about 90 weight percent to about 99.9 weight percent, based on the total weight of the composition.

The isomeric alkatrienyl alcohols can be present in the compositions of this disclosure in an amount from about 0 weight percent to about 99.9 weight percent, or from about 0 weight percent to about 90 weight percent, or from about 0 weight percent to about 80 weight percent, or from about 0 weight percent to about 70 weight percent, or from about 0 weight percent to about 60 weight percent, or from about 0 weight percent to about 50 weight percent, or from about 0 weight percent to about 40 weight percent, or from about 0 weight percent to about 30 weight percent, or from about 0 weight percent to about 20 weight percent, or from about 0 weight percent to about 10 weight percent, or from about 0.1 weight percent to about 99.9 weight percent, or from about 10 weight percent to about 99.9 weight percent, or from about 20 weight percent to about 99.9 weight percent, or from about 30 weight percent to about 99.9 weight percent, or from about 40 weight percent to about 99.9 weight percent, or from about 50 weight percent to about 99.9 weight percent, or from about 60 weight percent to about 99.9 weight percent, or from about 70 weight percent to about 99.9 weight percent, or from about 80 weight percent to about 99.9 weight percent, or from about 90 weight percent to about 99.9 weight percent, based on the total weight of the composition.

The composition of this disclosure can further include at least one alkyl alcohol and/or alkyl ester. A preferred alkyl alcohol and/or alkyl ester is hexadecyl alcohol and hexadecyl ester (e.g., an alkyl acetate such as hexadecyl acetate).

The at least one alkyl alcohol (e.g., hexadecyl alcohol) can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the weight of the composition.

The at least one alkyl ester (e.g., hexadecyl acetate) can be present in the compositions of this disclosure in an amount from about 0 percent to about 99.9 percent, or from about 0 percent to about 90 percent, or from about 0 percent to about 80 percent, or from about 0 percent to about 70 percent, or from about 0 percent to about 60 percent, or from about 0 percent to about 50 percent, or from about 0 percent to about 40 percent, or from about 0 percent to about 30 percent, or from about 0 percent to about 20 percent, or from about 0 percent to about 10 percent, or from about 0.1 percent to about 99.9 percent, or from about 10 percent to about 99.9 percent, or from about 20 percent to about 99.9 percent, or from about 30 percent to about 99.9 percent, or from about 40 percent to about 99.9 percent, or from about 50 percent to about 99.9 percent, or from about 60 percent to about 99.9 percent, or from about 70 percent to about 99.9 percent, or from about 80 percent to about 99.9 percent, or from about 90 percent to about 99.9 percent, based on the weight of the composition.

Illustrative isomeric alkatrienyl esters of this disclosure include, for example, isomeric hexadecatrienyl formates, isomeric hexadecatrienyl acetates, isomeric hexadecatrienyl propionates, isomeric hexadecatrienyl butyrates, isomeric hexadecatrienyl isobutyrates, isomeric hexadecatrienyl valerates, isomeric hexadecatrienyl isovalerates, isomeric hexadecatrienyl alpha methyl butyrates, isomeric hexadecatrienyl hexanoates and isomers thereof, isomeric hexadecatrienyl heptanoates and isomers thereof, and isomeric hexadecatrienyl octanoates and isomers thereof.

The compositions of this disclosure can further include one or more cocoa pod borer Conopomorpha cramerella insecticides, one or more cocoa pod borer Conopomorpha cramerella biological control agents, or combinations thereof.

The compositions of this disclosure can further include one or more organic volatile compounds produced and emitted from a fruit and/or plant of the botanical family Sapindaceae, Sterculiaceae, and/or Malvaceae.

The compositions of this disclosure can further include one or more allelochemicals or kairomones.

In an embodiment, the one or more allelochemicals or kairomones include one or more organic volatile compounds produced and emitted from a fruit and/or plant of the botanical family Sapindaceae, Sterculiaceae, and/or Malvaceae.

In an embodiment, the fruit and/or plant include, for example, cocoa, rambutan, Fiji

Longan, cola, and lychee.

In accordance with this disclosure, the one or more allelochemicals or kairomones are moths of the genus Conopomorpha attractants, or a male or female cocoa pod borer Conopomorpha cramerella attractant, or a male or female litchi fruit borer Conopomorpha sinensis attractant.

Allelochemicals include metabolic byproducts (secondary metabolites) released by plants, algae, bacteria, and fungi into the environment via roots, leaching, volatilization, or decomposition. Illustrative allelochemicals include, for example, phenolics such as flavonoids and tannins; terpenoids including sesquiterpene lactones; alkaloids such as common defensive compounds; and benzoxazinoids and glucosinolates.

The compositions of this disclosure can further include one or more additives or adjuvants. Illustrative additives or adjuvants include, for example, organic solvents, antioxidants, ultraviolet (UV) stabilizers, diluents, and combinations thereof.

Illustrative organic solvents include, for example, dichloromethane, hexane, acetone, ether, ethyl acetate, tetrahydrofuran, and combinations thereof.

Illustrative antioxidants include, for example, di-tert-butyl-4-methylphenol (BHT), butylated hydroxyanisole (BHA), 2,6-bis(1,1-dimethyl ethyl)-4-methylphenol (Bis BHT), tocophenol, and combinations thereof.

Illustrative ultraviolet (UV) stabilizers include, for example, ultraviolet (UV) absorbers, light stabilizers, and combinations thereof. A preferred ultraviolet (UV) absorber is oxybenzone. A preferred light stabilizer is a hindered amine light stabilizer (HALS).

Illustrative diluents include, for example, isopropyl myristate, dodecyl acetate, mineral oil, citric acid esters, and combinations thereof.

The compositions of this disclosure can be formulated into a solid or liquid formulation. The liquid formulation can be a sprayable or non-sprayable formulation. The solid formulation can be a thermoplastic matrix or laminate. The thermoplastic matrix can be polyethylene, polyvinyl chloride, polypropylene, ethylvinyl acetate, polystyrene, rubber, and any blends or combinations thereof.

In an embodiment, the compositions of this disclosure can be formulated into granules, dusts, soluble powders, wettable powders, pastes, emulsifiable concentrates, aerosols, ultra low-volume concentrates, flowable suspensions, oils, sprays, lures, biodegradable flakes, microcapsules, plastic flakes, emulsions, microemulsions, wax emulsions, pellets, natural waxes, synthetic waxes, resins, glues, puffers, membrane systems, film systems, pouches, bubble caps, blocks, monoliths, gels, polyacrylamide plugs, tablets, mesoporous materials, polymer tubes, or any combinations thereof.

In an embodiment, the compositions of this disclosure can be applied with a carrier component or carrier (e.g., agronomically or physiologically or pharmaceutically acceptable carrier). The carrier component can be a liquid or a solid material. The vehicle or carrier to be used refers to a substrate such as a membrane, hollow fiber, microcapsule, gel, polymers, bag, vial, septa, or the like. All of these substrates have been used to release volatile chemicals in general and are well known in the art. Suitable carriers are well-known in the art and are selected in accordance with volatility of the chemical and the ultimate application of interest. Agronomically acceptable substances include aqueous solutions, oils, glycols, alcohols, ketones, esters, hydrocarbons, halogenated hydrocarbons, polyvinyl chloride; in addition, solid carriers such as clays, cellulosic, fibers, and rubber materials and synthetic polymers. Suitable carriers are to be selected in accordance with the best application for the release of the attractant of this disclosure. Polyvinyl chloride is a carrier of interest, in addition, solid carriers such as clays, cellulosic and rubber materials and synthetic polymers.

Other compounds may be added to the compositions of his disclosure provided they do not substantially interfere with the intended activity and efficacy of the compositions.

### Synergistic Compositions

The synergistic compositions of this disclosure have: at least two isomeric alkatrienyl esters in an amount effective to attract moths of the genus Conopomorpha or male cocoa pod borer Conopomorpha cramerella; or at least two isomeric alkatrienyl alcohols in an amount effective to attract moths of the genus Conopomorpha or male cocoa pod borer Conopomorpha cramerella; or a combination of at least one isomeric alkatrienyl ester and at least one isomeric alkatrienyl alcohol in an amount effective to attract moths of the genus Conopomorpha or male cocoa pod borer Conopomorpha cramerella. The synergistic compositions produce, when the moths of the genus Conopomorpha or male cocoa pod borer Conopomorpha cramerella are exposed to the synergistic compositions, a combined attractancy effect greater than the sum of the separate attractancy effects from the separate isomeric components of the compositions, at comparable concentrations.

In an embodiment, in the synergistic compositions, the at the at least two isomeric alkatrienyl esters, or the at least two isomeric alkatrienyl alcohols, or the combination of at least one isomeric alkatrienyl ester and at least one isomeric alkatrienyl alcohol, each comprise a carbon backbone having from about 14 to about 18 carbon atoms, and from about two to about four unsaturated double bonds positioned on the carbon backbone, in which the unsaturated double bonds are conjugated or unconjugated, and have an isomer configuration of cis, trans, or a combination or cis and trans.

The synergistic compositions of this disclosure can further include at least one alkyl alcohol. An illustrative alkyl alcohol is hexadecyl alcohol.

The synergistic compositions of this disclosure can further include at least one alkyl ester such as alkyl acetate. An illustrative alkyl acetate is hexadecyl acetate.

The synergistic compositions of this disclosure can further include one or more organic volatile compounds produced and emitted from a fruit and/or plant of the botanical family Sapindaceae, Sterculiaceae, and/or Malvaceae.

The synergistic compositions of this disclosure can further include one or more allelochemicals or kairomones.

In an embodiment, the one or more allelochemicals or kairomones include one or more organic volatile compounds produced and emitted from a fruit and/or plant of the botanical family Sapindaceae, Sterculiaceae, and/or Malvaceae.

In an embodiment, the fruit and/or plant include, for example, cocoa, rambutan,

Fiji Longan, cola, and lychee.

In accordance with this disclosure, the one or more allelochemicals or kairomones are moths of the genus Conopomorpha attractants, or a male or female cocoa pod borer Conopomorpha cramerella attractant, or a male or female litchi fruit borer Conopomorpha sinensis attractant.

In an embodiment, the synergistic compositions of this disclosure have at least one isomeric alkatrienyl ester in an amount effective to attract moths of the genus Conopomorpha or cocoa pod borer Conopomorpha cramerella; and at least one allelochemical or kairomone in an amount effective to attract moths of the genus Conopomorpha or cocoa pod borer Conopomorpha cramerella. The at least one isomeric alkatrienyl ester comprises (E,Z,Z)-4,6,10-hexadecatrienyl acetate and (Z,E,Z)-4,6,10-hexadecatrienyl acetate, and the at least one allelochemical or kairomone comprises one or more organic volatile compounds produced and emitted from a fruit and/or plant of the botanical family Sapindaceae, Sterculiaceae, and/or Malvaceae. The synergistic composition produces, when the moths of the genus Conopomorpha or cocoa pod borer Conopomorpha cramerella are exposed to the synergistic composition, a combined attractancy effect greater than the sum of the separate attractancy effects from the separate alkatrienyl ester and allelochemical or kairomone components of said composition, at comparable concentrations.

Other compounds may be added to the synergistic compositions of his disclosure provided they do not substantially interfere with the intended activity and efficacy of the synergistic compositions.

### Method of Attracting Male Cocoa Pod Borer

This disclosure relates to a method of attracting moths of the genus Conopomorpha or male cocoa pod borer Conopomorpha cramerella by treating an object or area with a composition, or a synergistic composition, of this disclosure. The composition, or the synergistic composition, can be in a trap. The composition is used in an amount effective to attract moths of the genus Conopomorpha or male cocoa pod borer Conopomorpha cramerella.

The amount of the composition for attracting moths of the genus Conopomorpha or male cocoa pod borer Conopomorpha cramerella used in the method of this disclosure will be at least an effective amount (e.g., 1 mg or more). The term “effective amount,” as used herein, means the minimum amount of the composition needed to attract moths of the genus Conopomorpha or male cocoa pod borer Conopomorpha cramerella to a treated area or object or locus when compared to the same area or object or locus which is untreated. The precise amount needed will vary in accordance with the particular composition used; the type of area or object to be treated; the number of days of attractiveness needed; and the environment in which the area or object or locus is located.

For example, the composition will be statistically significant in comparison to a control (e.g., water). Generally, the concentrations of the compositions of this disclosure on a substrate will range from about 5 mg to about 300 mg, or from about 5 mg to about 250 mg, or from about 10 mg to about 250 mg; monitoring traps will generally use from about 25 mg to about 75 mg, or from about 30 mg to about 70 mg, or from about 40 mg to about 60 mg; while attract and kill will typically use from about 100 to about 400 mg, from about 150 to about 350 mg, or from about 200 to about 300 mg. Release rates can generally be about 0.01 to about 50 mg, or about 0.05 to about 40 mg, or about 0.05 to about 30 mg, per lure per day.

### Method of Monitoring Cocoa Pod Borer

This disclosure relates to a method of monitoring moths of the genus Conopomorpha or cocoa pod borer Conopomorpha cramerella in an area. The method involves providing a trap having a lure. The lure includes the composition, or the synergistic composition, of this disclosure. The method further involves positioning the trap in the area, and observing moths of the genus Conopomorpha or cocoa pod borer Conopomorpha cramerella captures in the trap over a period of time. The composition is used in an amount effective to attract moths of the genus Conopomorpha or male cocoa pod borer Conopomorpha cramerella.

In an embodiment, the lure can be a thermoplastic vial impregnated with the composition, or the synergistic composition, of this disclosure. The lure can also be a rubber septa impregnated with the composition, or the synergistic composition, of this disclosure.

In an embodiment, the trap is selected from a delta trap, a bucket trap, a water trap, and a funnel trap.

In an embodiment, the trap can be a delta trap having an adhesive liner.

In an embodiment, the area can be a cacao orchard, or a rambutan orchard, or a Fiji Longan orchard, or a cola orchard, or a lychee orchard.

The amount of the composition for attracting moths of the genus Conopomorpha or male cocoa pod borer Conopomorpha cramerella used in the method of this disclosure will be at least an effective amount (i.e., 1 mg or more). The term “effective amount,” as used herein, means the minimum amount of the composition needed to attract moths of the genus Conopomorpha or male cocoa pod borer Conopomorpha cramerella to a treated area or object or locus when compared to the same area or object or locus which is untreated. The precise amount needed will vary in accordance with the particular composition used; the type of area or object to be treated; the number of days of attractiveness needed; and the environment in which the area or object or locus is located.

For example, the composition will be statistically significant in comparison to a control (e.g., water). Generally, the concentrations of the compositions of this disclosure on a substrate will range from about 5 mg to about 300 mg, or from about 5 mg to about 250 mg, or from about 10 mg to about 250 mg; monitoring traps will generally use from about 25 mg to about 75 mg, or from about 30 mg to about 70 mg, or from about 40 mg to about 60 mg; while attract and kill will typically use from about 100 to about 400 mg, from about 150 to about 350 mg, or from about 200 to about 300 mg. Release rates can generally be about 0.01 to about 50 mg, or about 0.05 to about 40 mg, or about 0.05 to about 30 mg, per lure per day.

### Method of Controlling Cocoa Pod Borer

This disclosure also relates to a method of controlling moths of the genus Conopomorpha or cocoa pod borer Conopomorpha cramerella by exposing the moths of the genus Conopomorpha or cocoa pod borer Conopomorpha cramerella to an effective amount of the composition, or the synergistic composition, of this disclosure. The composition is used in an amount effective to attract moths of the genus Conopomorpha or male cocoa pod borer Conopomorpha cramerella.

In an embodiment, the method can be carried out by mass trapping, or by disrupting mating behavior of moths of the genus Conopomorpha or cocoa pod borer Conopomorpha cramerella, or by releasing the composition, or the synergistic composition, of this disclosure, into an area.

In an embodiment, the composition is released in cacao fields within the total area, perimeter, border, internal areas, external areas, or any combination thereof.

The method can be attract and kill and is carried out by combining the composition, or the synergistic composition, of this disclosure, with one or more moths of the genus Conopomorpha or cocoa pod borer Conopomorpha cramerella insecticides, one or more moths of the genus Conopomorpha or cocoa pod borer Conopomorpha cramerella biological control agents, or a combination thereof.

In an embodiment, attract and kill is carried out by ingestion or contact. The ingestion includes a bait in association with phagostimulants, adjuvants, and/or insecticides. The contact includes a tank mix in association with an insecticide spray solution.

The amount of the composition for attracting moths of the genus Conopomorpha or male cocoa pod borer Conopomorpha cramerella used in the method of this disclosure will be at least an effective amount (i.e., 1 mg or more). The term “effective amount,” as used herein, means the minimum amount of the composition needed to attract moths of the genus Conopomorpha or male cocoa pod borer Conopomorpha cramerella to a treated area or object or locus when compared to the same area or object or locus which is untreated. The precise amount needed will vary in accordance with the particular composition used; the type of area or object to be treated; the number of days of attractiveness needed; and the environment in which the area or object or locus is located.

For example, the composition will be statistically significant in comparison to a control (e.g., water). Generally, the concentrations of the compositions of this disclosure on a substrate will range from about 5 mg to about 300 mg, or from about 5 mg to about 250 mg, or from about 10 mg to about 250 mg; monitoring traps will generally use from about 25 mg to about 75 mg, or from about 30 mg to about 70 mg, or from about 40 mg to about 60 mg; while attract and kill will typically use from about 100 to about 400 mg, from about 150 to about 350 mg, or from about 200 to about 300 mg. Release rates can generally be about 0.01 to about 50 mg, or about 0.05 to about 40 mg, or about 0.05 to about 30 mg, per lure per day.

### Trap Configured for Capturing Cocoa Pod Borer

This disclosure relates to a trap configured for capturing moths of the genus Conopomorpha or cocoa pod borer Conopomorpha cramerella. The trap has a lure which includes the composition, or the synergistic composition, of this disclosure.

In an embodiment, the trap can be a delta trap, a bucket trap, a water trap, or a funnel trap.

In a preferred embodiment, the trap can be a delta trap. The delta trap can have an adhesive liner. The lure can be a thermoplastic vial impregnated with the composition, or the synergistic composition, of this disclosure. The lure can be a rubber septa impregnated with the composition, or the synergistic composition, of this disclosure.

### Substrates

This disclosure relates to substrates having the composition, or the synergistic composition, of this disclosure, on a surface or impregnated therein. The substrate can be a trap or a lure. The trap can be a delta trap. The lure can be a vial, rubber septum, or reservoir container. The vial can be a plastic vial. The plastic can be selected from polyethylene, polyvinyl chloride, polypropylene, ethylvinyl acetate, polystyrene, rubber, and any blends or combinations thereof. The lure can be a rubber septum. The rubber can be selected from natural rubber, halobutyl rubber, gum rubber, and combinations thereof. The lure can be a plastic film or laminate reservoir container. The plastic film can be selected from polyethylene, polyvinyl chloride, polypropylene, ethylvinyl acetate, polystyrene, rubber, and any blends or combinations thereof.

### Processes of Manufacture

In accordance with this disclosure, processes are provided for preparing the composition, or the synergistic composition, of this disclosure.

One process involves providing at least one isomeric alkatrienyl ester; and blending the at least one isomeric alkatrienyl ester and optional ingredients in an amount effective to attract moths of the genus Conopomorpha or cocoa pod borer Conopomorpha cramerella.

Another process involves providing at least one isomeric alkatrienyl alcohol; and blending the at least one isomeric alkatrienyl alcohol and optional ingredients in an amount effective to attract moths of the genus Conopomorpha or cocoa pod borer Conopomorpha cramerella.

Still another process involves providing at least one isomeric alkatrienyl ester; providing at least one isomeric alkatrienyl alcohol; and blending the at least one isomeric alkatrienyl ester and the at least one isomeric alkatrienyl alcohol in an amount effective to attract moths of the genus Conopomorpha or cocoa pod borer Conopomorpha cramerella

In the processes of this disclosure, the at least one isomeric alkatrienyl ester is selected from (E,E,E)-4,6,10-hexadecatrienyl acetate, (E,E,Z)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, (Z,E,Z)-4,6,10-hexadecatrienyl acetate, and (E,Z,Z)-4,6,10-hexadecatrienyl acetate. The at least one isomeric alkatrienyl ester can be alone or in combination with at least one isomeric alkatrienyl alcohol of this disclosure.

In the processes of this disclosure, the at least one isomeric alkatrienyl alcohol is selected from (E,E,E)-4,6,10-hexadecatrienol, (E,E,Z)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, (Z,E,Z)-4,6,10-hexadecatrienol, and (E,Z,Z)-4,6,10-hexadecatrienol. The at least one isomeric alkatrienyl alcohol can be alone or in combination with at least one isomeric alkatrienyl ester of this disclosure.

In the processes of this disclosure, the at least one isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition. The amounts of isomers of the at least one isomeric alkatrienyl ester can be alone amounts or amounts in combination with the isomers of the at least one isomeric alkatrienyl alcohol of this disclosure.

In the process of this disclosure, the at least one isomeric alkatrienyl alcohol has from about 0 percent to about 99.9 percent, or from about 0.01 percent to about 95 percent, or from about 0.1 percent to about 90 percent, of E,E,E isomers; from about 0 percent to about 99.9 percent, or from about 0.05 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.05 percent to about 95 percent, or from about 0.1 percent to about 90 percent, of E,Z,Z isomers; based on the total isomers in the composition. The amounts of isomers of the at least one isomeric alkatrienyl alcohol can be alone amounts or amounts in combination with the isomers of the at least one isomeric alkatrienyl ester of this disclosure.

The alkatrienyl esters and alkatrienyl alcohols can be prepared by conventional processes known in the art. For example, see P. S. Beevor et al., Components of Female Sex Pheromone of Cocoa Pod Borer Moth, Conopomorpha cramerella, Journal of Chemical Ecology, Vo;. 12, No. 1, 1986. Reaction conditions (e.g., temperature, pressure, reaction time, etc.) may vary depending on the desired isomers sought to be obtained. The reaction conditions may be determined while considering the reactivity of starting materials and/or the yield of the desired isomers.

The above processes of this disclosure can be carried out by conventional procedures known in the art. For example, see P. S. Beevor et al., supra. Blending conditions (e.g., temperature, pressure, reaction time, etc.) may vary depending on the desired compositions sought to be obtained. The processing conditions may be determined while considering the yield of the desired blend.

This disclosure provides yet other processes for preparing the compositions of this disclosure, and the synergistic compositions of this disclosure. One such process involves: providing a synthetic pheromone of cocoa pod borer Conopomorpha cramerella impregnated in, or on a surface of, a substrate; and subjecting the synthetic pheromone and substrate to reaction conditions sufficient to form the composition of this disclosure, or the synergistic composition of this disclosure.

In an embodiment, the substrate is a trap or a lure. The trap can be a delta trap. The lure can be a vial, rubber septum, or reservoir container.

The vial can be a plastic vial. The plastic can be, for example, polyethylene, polyvinyl chloride, polypropylene, ethylvinyl acetate, polystyrene, rubber, and any blends or combinations thereof.

The lure can be a rubber septum. The rubber can be, for example, natural rubber, halobutyl rubber, gum rubber, and combinations thereof.

The lure can be a plastic film or laminate reservoir container. The plastic film can be, for example, polyethylene, polyvinyl chloride, polypropylene, ethylvinyl acetate, polystyrene, rubber, and any blends or combinations thereof.

The synthetic pheromone can be prepared by conventional processes known in the art. For example, see P. S. Beevor et al., supra.

The process is conducted under reaction conditions sufficient to form the compositions of this disclosure, and the synergistic compositions of this disclosure. Suitable reaction conditions include, for example, a temperature from about 25° C. to about 50° C., a pressure from about 1000 to about 1025 hectopascal (hPa), a relative humidity ranging between about 70% and about 90%, and a reaction time from about 1 minute or less to about 24 hours or longer.

Another such process involves: providing a synthetic pheromone of cocoa pod borer Conopomorpha cramerella; and reacting the synthetic pheromone in the presence of a catalyst and under reaction conditions sufficient to form the composition of this disclosure, or the synergistic composition of this disclosure.

In accordance with this process, the synthetic pheromone and the catalyst can be impregnated in, or on a surface of, a substrate. The substrate can be a trap or a lure.

The trap can be, for example, a delta trap. The lure can be, for example, a vial, rubber septum, or reservoir container.

The vial can be a plastic vial. The plastic can be, for example, polyethylene, polyvinyl chloride, polypropylene, ethylvinyl acetate, polystyrene, rubber, and any blends or combinations thereof.

The lure can be a rubber septum. The rubber can be, for example, natural rubber, halobutyl rubber, gum rubber, and combinations thereof.

The lure can be a plastic film or laminate reservoir container. The plastic film can be, for example, polyethylene, polyvinyl chloride, polypropylene, ethylvinyl acetate, polystyrene, rubber, and any blends or combinations thereof.

The synthetic pheromone can be prepared by conventional processes known in the art. For example, see P. S. Beevor et al., supra.

The catalyst can be an olefin isomerization catalyst. The olefin isomerization catalyst can be, for example, sulfur or a thiol.

This process is conducted under reaction conditions sufficient to form the compositions of this disclosure, and the synergistic compositions of this disclosure. Suitable reaction conditions include, for example, a temperature from about 25° C. to about 50° C., a pressure from about 1000 to about 1025 hectopascal (hPa), a relative humidity ranging between about 70% and about 90%, and a reaction time from about 1 minute or less to about 24 hours or longer.

The compositions of this disclosure can be formulated to exhibit desired attraction activity. It is usually necessary to add other substances so that the composition may be used at the required concentration and in an appropriate form, permitting ease of application, handling, transportation, storage, and maximum control or repellant activity. Thus, the compositions of this disclosure can be formulated into, for example, solids or liquids, sprayable and non-sprayable.

The compositions of this disclosure may be applied to any locus. Particular loci to apply such compositions include loci where cocoa is growing.

Preferred embodiments of this disclosure are set forth in the clauses below.

### Compositions

1. A composition comprising: at least one isomeric alkatrienyl ester in an amount effective to attract moths of the genus Conopomorpha or male cocoa pod borer Conopomorpha cramerella; or at least one isomeric alkatrienyl alcohol in an amount effective to attract moths of the genus Conopomorpha or male cocoa pod borer Conopomorpha cramerella; or a combination of at least one isomeric alkatrienyl ester and at least one isomeric alkatrienyl alcohol in an amount effective to attract moths of the genus Conopomorpha or male cocoa pod borer Conopomorpha cramerella; wherein attraction of moths of the genus Conopomorpha or male cocoa pod borer Conopomorpha cramerella is improved as compared to attraction of moths of the genus Conopomorpha or male cocoa pod borer Conopomorpha cramerella with a composition other than said composition.
2. The composition of clause 1 wherein moths of the genus Conopomorpha are selected from the group consisting of Conopomorpha cramerella, Conopomorpha sinensis, Conopomorpha antimacha, Conopomorpha chionochtha, Conopomorpha chionosema, Conopomorpha cyanospila, Conopomorpha euphanes, Conopomorpha flueggella, Conopomorpha fustigera, Conopomorpha habrodes, Conopomorpha heliopla, Conopomorpha litchiella, Conopomorpha oceanica, and Conopomorpha zaplaca.
3. The composition of clause 1 wherein moths of the genus Conopomorpha are selected from the group consisting of Conopomorpha cramerella and Conopomorpha sinensis.
4. The composition of clause 1 wherein moths of the genus Conopomorpha are the male cocoa pod borer Conopomorpha cramerella.
5. The composition of clauses 1-4 comprising: at least two isomeric alkatrienyl esters; or at least three isomeric alkatrienyl esters; or at least four isomeric alkatrienyl esters; or at least five isomeric alkatrienyl esters; or at least six isomeric alkatrienyl esters; or at least seven isomeric alkatrienyl esters; or at least eight isomeric alkatrienyl esters; all alone or in combination with the at least one or more isomeric alkatrienyl alcohols.
6. The composition of clauses 1-4 comprising: at least two isomeric alkatrienyl alcohols; or at least three isomeric alkatrienyl alcohols; or at least four isomeric alkatrienyl alcohols; or at least five isomeric alkatrienyl alcohols; or at least six isomeric alkatrienyl alcohols; or at least seven isomeric alkatrienyl alcohols; or at least eight isomeric alkatrienyl alcohols; all alone or in combination with the at least one or more isomeric alkatrienyl esters.
7. The composition of clauses 1-4 comprising: at least one isomeric alkatrienyl ester and at least one isomeric alkatrienyl alcohol; or at least one isomeric alkatrienyl ester and at least two isomeric alkatrienyl alcohols; or at least one isomeric alkatrienyl ester and at least three isomeric alkatrienyl alcohols; or at least one isomeric alkatrienyl ester and at least four isomeric alkatrienyl alcohols; or at least one isomeric alkatrienyl ester and at least five isomeric alkatrienyl alcohols; or at least one isomeric alkatrienyl ester and at least six isomeric alkatrienyl alcohols; or at least one isomeric alkatrienyl ester and at least seven isomeric alkatrienyl alcohols; or at least one isomeric alkatrienyl ester and at least eight isomeric alkatrienyl alcohols.
8. The composition of clauses 1-4 comprising: at least two isomeric alkatrienyl esters and at least one isomeric alkatrienyl alcohol; or at least two isomeric alkatrienyl esters and at least two isomeric alkatrienyl alcohols; or at least two isomeric alkatrienyl esters and at least three isomeric alkatrienyl alcohols; or at least two isomeric alkatrienyl esters and at least four isomeric alkatrienyl alcohols; or at least two isomeric alkatrienyl esters and at least five isomeric alkatrienyl alcohols; or at least two isomeric alkatrienyl esters and at least six isomeric alkatrienyl alcohols; or at least two isomeric alkatrienyl esters and at least seven isomeric alkatrienyl alcohols; or at least two isomeric alkatrienyl esters and at least eight isomeric alkatrienyl alcohols.
9. The composition of clauses 1-4 comprising: at least three isomeric alkatrienyl esters and at least one isomeric alkatrienyl alcohol; or at least three isomeric alkatrienyl esters and at least two isomeric alkatrienyl alcohols; or at least three isomeric alkatrienyl esters and at least three isomeric alkatrienyl alcohols; or at least three isomeric alkatrienyl esters and at least four isomeric alkatrienyl alcohols; or at least three isomeric alkatrienyl esters and at least five isomeric alkatrienyl alcohols; or at least three isomeric alkatrienyl esters and at least six isomeric alkatrienyl alcohols; or at least three isomeric alkatrienyl esters and at least seven isomeric alkatrienyl alcohols; or at least three isomeric alkatrienyl esters and at least eight isomeric alkatrienyl alcohols.
10. The composition of clauses 1-4 comprising: at least four isomeric alkatrienyl esters and at least one isomeric alkatrienyl alcohol; or at least four isomeric alkatrienyl esters and at least two isomeric alkatrienyl alcohols; or at least four isomeric alkatrienyl esters and at least three isomeric alkatrienyl alcohols; or at least four isomeric alkatrienyl esters and at least four isomeric alkatrienyl alcohols; or at least four isomeric alkatrienyl esters and at least five isomeric alkatrienyl alcohols; or at least four isomeric alkatrienyl esters and at least six isomeric alkatrienyl alcohols; or at least four isomeric alkatrienyl esters and at least seven isomeric alkatrienyl alcohols; or at least four isomeric alkatrienyl esters and at least eight isomeric alkatrienyl alcohols.
11. The composition of clauses 1-4 comprising: at least five isomeric alkatrienyl esters and at least one isomeric alkatrienyl alcohol; or at least five isomeric alkatrienyl esters and at least two isomeric alkatrienyl alcohols; or at least five isomeric alkatrienyl esters and at least three isomeric alkatrienyl alcohols; or at least five isomeric alkatrienyl esters and at least four isomeric alkatrienyl alcohols; or at least five isomeric alkatrienyl esters and at least five isomeric alkatrienyl alcohols; or at least five isomeric alkatrienyl esters and at least six isomeric alkatrienyl alcohols; or at least five isomeric alkatrienyl esters and at least seven isomeric alkatrienyl alcohols; or at least five isomeric alkatrienyl esters and at least eight isomeric alkatrienyl alcohols.
12. The composition of clauses 1-4 comprising: at least six isomeric alkatrienyl esters and at least one isomeric alkatrienyl alcohol; or at least six isomeric alkatrienyl esters and at least two isomeric alkatrienyl alcohols; or at least six isomeric alkatrienyl esters and at least three isomeric alkatrienyl alcohols; or at least six isomeric alkatrienyl esters and at least four isomeric alkatrienyl alcohols; or at least six isomeric alkatrienyl esters and at least five isomeric alkatrienyl alcohols; or at least six isomeric alkatrienyl esters and at least six isomeric alkatrienyl alcohols; or at least six isomeric alkatrienyl esters and at least seven isomeric alkatrienyl alcohols; or at least six isomeric alkatrienyl esters and at least eight isomeric alkatrienyl alcohols.
13. The composition of clauses 1-4 comprising: at least seven isomeric alkatrienyl esters and at least one isomeric alkatrienyl alcohol; or at least seven isomeric alkatrienyl esters and at least two isomeric alkatrienyl alcohols; or at least seven isomeric alkatrienyl esters and at least three isomeric alkatrienyl alcohols; or at least seven isomeric alkatrienyl esters and at least four isomeric alkatrienyl alcohols; or at least seven isomeric alkatrienyl esters and at least five isomeric alkatrienyl alcohols; or at least seven isomeric alkatrienyl esters and at least six isomeric alkatrienyl alcohols; or at least seven isomeric alkatrienyl esters and at least seven isomeric alkatrienyl alcohols; or at least seven isomeric alkatrienyl esters and at least eight isomeric alkatrienyl alcohols.
14. The composition of clauses 1-4 comprising: at least eight isomeric alkatrienyl esters and at least one isomeric alkatrienyl alcohol; or at least eight isomeric alkatrienyl esters and at least two isomeric alkatrienyl alcohols; or at least eight isomeric alkatrienyl esters and at least three isomeric alkatrienyl alcohols; or at least eight isomeric alkatrienyl esters and at least four isomeric alkatrienyl alcohols; or at least eight isomeric alkatrienyl esters and at least five isomeric alkatrienyl alcohols; or at least eight isomeric alkatrienyl esters and at least six isomeric alkatrienyl alcohols; or at least eight isomeric alkatrienyl esters and at least seven isomeric alkatrienyl alcohols; or at least eight isomeric alkatrienyl esters and at least eight isomeric alkatrienyl alcohols.
15. The composition of clauses 1-14 which is a male cocoa pod borer Conopomorpha cramerella attractant.
16. The composition of clauses 1-14 wherein attraction of moths of the genus Conopomorpha or attraction of male cocoa pod borer Conopomorpha cramerella, is improved greater than about 10%, or greater than about 20%, or greater than about 30%, or greater than about 40%, or greater than about 50%, or greater than about 60%, or greater than about 70%, or greater than about 80%, or greater than about 90%, as compared to attraction of moths of the genus Conopomorpha or attraction of male cocoa pod borer Conopomorpha cramerella with a composition other than said composition.
17. The composition of clause 1 wherein the at least one isomeric alkatrienyl ester, or the at least one isomeric alkatrienyl alcohol, or the combination of the at least one isomeric alkatrienyl ester and at least one isomeric alkatrienyl alcohol, each comprise a carbon backbone having from about 14 to about 18 carbon atoms, and from about two to about four unsaturated double bonds positioned on the carbon backbone, in which the unsaturated double bonds are conjugated or unconjugated, and have an isomer configuration of cis, trans, or a combination or cis and trans.
18. The composition of clause 5 wherein the at least one isomeric alkatrienyl ester, or the at least two isomeric alkatrienyl esters; or the at least three isomeric alkatrienyl esters; or the at least four isomeric alkatrienyl esters; or the at least five isomeric alkatrienyl esters; or the at least six isomeric alkatrienyl esters; or the at least seven isomeric alkatrienyl esters; or the at least eight isomeric alkatrienyl esters, are selected from the group consisting of (E,E,E)-4,6,10-hexadecatrienyl acetate, (E,E,Z)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, (Z,E,Z)-4,6,10-hexadecatrienyl acetate, and (E,Z,Z)-4,6,10-hexadecatrienyl acetate.
19. The composition of clause 6 wherein the at least one isomeric alkatrienyl alcohol, or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols, are selected from the group consisting of (E,E,E)-4,6,10-hexadecatrienol, (E,E,Z)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, (Z,E,Z)-4,6,10-hexadecatrienol, and (E,Z,Z)-4,6,10-hexadecatrienol.
20. The composition of clause 7 wherein the at least one isomeric alkatrienyl ester is selected from the group consisting of (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate.
21. The composition of clause 20 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols, are selected from the group consisting of (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.
22. The composition of clause 8 wherein the at least two isomeric alkatrienyl esters are selected from the group consisting of (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate.
23. The composition of clause 22 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from the group consisting of (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.
24. The composition of clause 9 wherein the at least three isomeric alkatrienyl esters are selected from the group consisting of (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate.
25. The composition of clause 24 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from the group consisting of (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.
26. The composition of clause 10 wherein the at least four isomeric alkatrienyl esters are selected from the group consisting of (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate.
27. The composition of clause 26 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from the group consisting of (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.
28. The composition of clause 11 wherein the at least five isomeric alkatrienyl esters are selected from the group consisting of (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate.
29. The composition of clause 28 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from the group consisting of (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.
30. The composition of clause 12 wherein the at least six isomeric alkatrienyl esters are selected from the group consisting of (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate.
31. The composition of clause 30 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from the group consisting of (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.
32. The composition of clause 13 wherein the at least seven isomeric alkatrienyl esters are selected from the group consisting of (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate.
33. The composition of clause 32 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from the group consisting of (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.
34. The composition of clause 14 wherein the at least eight isomeric alkatrienyl esters are selected from the group consisting of (E,E,Z)-4,6,10-hexadecatrienyl acetate, (E,Z,Z)-4,6,10-hexadecatrienyl acetate, (E,E,E)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, and (Z,E,Z)-4,6,10-hexadecatrienyl acetate.
35. The composition of clause 34 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols are selected from the group consisting of (E,E,Z)-4,6,10-hexadecatrienol, (E,Z,Z)-4,6,10-hexadecatrienol, (E,E,E)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, and (Z,E,Z)-4,6,10-hexadecatrienol.
36. The composition of clauses 1-4 wherein the at least one isomeric alkatrienyl ester comprises (E,E,Z)-4,6,10-hexadecatrienyl acetate, (E,Z,Z)-4,6,10-hexadecatrienyl acetate, and (Z,E,Z)-4,6,10-hexadecatrienyl acetate; all alone or in combination with the at least one or more isomeric alkatrienyl alcohols.
37. The composition of clauses 1-4 wherein the at least one isomeric alkatrienyl alcohol comprises (E,E,Z)-4,6,10-hexadecatrienol, (E,Z,Z)-4,6,10-hexadecatrienol, and (Z,E,Z)-4,6,10-hexadecatrienol; all alone or in combination with the at least one or more isomeric alkatrienyl esters.
38. The composition of clauses 1-4 wherein the at least one isomeric alkatrienyl ester comprises (E,E,Z)-4,6,10-hexadecatrienyl acetate, (E,Z,Z)-4,6,10-hexadecatrienyl acetate, and another isomeric alkatrienyl ester; all alone or in combination with the at least one or more isomeric alkatrienyl alcohols.
39. The composition of clauses 1-4 wherein the at least one isomeric alkatrienyl alcohol comprises (E,E,Z)-4,6,10-hexadecatrienol, (E,Z,Z)-4,6,10-hexadecatrienol, and another isomeric alkatrienyl alcohol; all alone or in combination with the at least one or more isomeric alkatrienyl esters.
40. The composition of clauses 1-4 wherein the at least one isomeric alkatrienyl ester comprises (E,E,Z)-4,6,10-hexadecatrienyl acetate, (E,Z,Z)-4,6,10-hexadecatrienyl acetate, (Z,E,Z)-4,6,10-hexadecatrienyl acetate, and another isomeric alkatrienyl ester; all alone or in combination with the at least one or more isomeric alkatrienyl alcohols.
41. The composition of clauses 1-4 wherein the at least one isomeric alkatrienyl alcohol comprises (E,E,Z)-4,6,10-hexadecatrienol, (E,Z,Z)-4,6,10-hexadecatrienol, (Z,E,Z)-4,6,10-hexadecatrienol, and another isomeric alkatrienyl alcohol; all alone or in combination with the at least one or more isomeric alkatrienyl esters.
42. The composition of clauses 1-4 wherein the at least one isomeric alkatrienyl ester, alone or in combination with the at least one isomeric alkatrienyl alcohol, has from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.
43. The composition of clauses 1-4 wherein the at least one isomeric alkatrienyl alcohol, alone or in combination with the at least one isomeric alkatrienyl ester, has from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.
44. The composition of clause 5 wherein the at least one isomeric alkatrienyl ester has from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.
45. The composition of clause 6 wherein the at least one isomeric alkatrienyl alcohol has from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.
46. The composition of clause 7 wherein the at least one isomeric alkatrienyl ester has from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.
47. The composition of clause 46 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols; have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.
48. The composition of clause 8 wherein the at least two isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.
49. The composition of clause 48 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols; have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.
50. The composition of clause 9 wherein the at least three isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.
51. The composition of clause 50 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols; have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.
52. The composition of clause 10 wherein the at least four isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.
53. The composition of clause 52 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols;, has from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.
54. The composition of clause 11 wherein the at least five isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.
55. The composition of clause 54 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols;, have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.
56. The composition of clause 12 wherein the at least six isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.
57. The composition of clause 56 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols, have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.
58. The composition of clause 13 wherein the at least seven isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.
59. The composition of clause 58 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols;, have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.
60. The composition of clause 14 wherein the at least eight isomeric alkatrienyl esters have from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.
61. The composition of clause 60 wherein the at least one isomeric alkatrienyl alcohol; or the at least two isomeric alkatrienyl alcohols; or the at least three isomeric alkatrienyl alcohols; or the at least four isomeric alkatrienyl alcohols; or the at least five isomeric alkatrienyl alcohols; or the at least six isomeric alkatrienyl alcohols; or the at least seven isomeric alkatrienyl alcohols; or the at least eight isomeric alkatrienyl alcohols;, have from about 0 percent to about 99.9 percent, or from about 0.01 percent to about 95 percent, or from about 0.1 percent to about 90 percent, of E,E,E isomers; from about 0 percent to about 99.9 percent, or from about 0.01 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.01 percent to about 95 percent, or from about 0.1 percent to about 90 percent, of E,Z,Z isomers; based on the total isomers in the composition.
62. The composition of clauses 1-4 further comprising at least one alkyl alcohol, at least one alkyl ester, or a combination thereof.
63. The composition of clause 62 wherein the at least one alkyl alcohol is hexadecyl alcohol; and the at least one alkyl ester is hexadecyl ester or hexadecyl acetate.
64. The composition of clause 62 wherein the at least one alkyl alcohol is present in an amount from about 0 percent to about 99.9 percent, or from about 0.01 percent to about 95 percent, or from about 0.1 percent to about 90 percent, based on the weight of the composition; and the at least one alkyl ester is present in an amount from about 0 percent to about 99.9 percent, or from about 0.01 percent to about 95 percent, or from about 0.1 percent to about 90 percent, based on the weight of the composition.
65. The composition of clauses 1-4 wherein the at least one isomeric alkatrienyl ester is selected from the group consisting of isomeric hexadecatrienyl formates, isomeric hexadecatrienyl acetates, isomeric hexadecatrienyl propionates, isomeric hexadecatrienyl butyrates, isomeric hexadecatrienyl isobutyrates, isomeric hexadecatrienyl valerates, isomeric hexadecatrienyl isovalerates, isomeric hexadecatrienyl alpha methyl butyrates, isomeric hexadecatrienyl hexanoates and isomers thereof, isomeric hexadecatrienyl heptanoates and isomers thereof, and isomeric hexadecatrienyl octanoates and isomers thereof.
66. The composition of clause 1-4 further comprising one or more cocoa pod borer Conopomorpha cramerella insecticides.
67. The composition of clauses 1-4 further comprising one or more cocoa pod borer Conopomorpha cramerella biological control agents.
68. The composition of clauses 1-4 further comprising one or more cocoa pod borer Conopomorpha cramerella insecticides, and one or more cocoa pod borer Conopomorpha cramerella biological control agents.
69. The composition of clauses 1-4 further comprising one or more organic volatile compounds produced and emitted from a fruit and/or plant of the botanical family Sapindaceae, Sterculiaceae, and/or Malvaceae.
70. The composition of clauses 1-4 further comprising one or more allelochemicals or kairomones.
71. The composition of clause 70 wherein the one or more allelochemicals or kairomones comprise one or more organic volatile compounds produced and emitted from a fruit and/or plant of the botanical family Sapindaceae, Sterculiaceae, and/or Malvaceae.
72. The composition of clause 71 wherein the fruit and/or plant is selected from the group consisting of cocoa, rambutan, Fiji Longan, cola, and lychee.
73. The composition of clause 70 wherein the one or more allelochemicals or kairomones are moths of the genus Conopomorpha attractants, or a male or female cocoa pod borer Conopomorpha cramerella attractant, or a male or female litchi fruit borer Conopomorpha sinensis attractant.
74. The composition of clauses 1-4 further comprising one or more additives or adjuvants.
75. The composition of clause 74 wherein the one or more additives or adjuvants are selected from the group consisting of organic solvents, antioxidants, ultraviolet (UV) stabilizers, diluents, and combinations thereof.
76. The composition of clause 74 wherein the or more organic solvents are selected from the group consisting of dichloromethane, hexane, acetone, ether, ethyl acetate, tetrahydrofuran, and combinations thereof.
77. The composition of clause 74 wherein the or more antioxidants are selected from the group consisting of di-tert-butyl-4-methylphenol (BHT), butylated hydroxyanisole (BHA), 2,6-bis(1,1-dimethyl ethyl)-4-methylphenol (Bis BHT), tocophenol, and combinations thereof.
78. The composition of clause 74 wherein the one or more ultraviolet (UV) stabilizers comprise ultraviolet (UV) absorbers, light stabilizers, and combinations thereof.
79. The composition of clause 78 wherein the ultraviolet (UV) absorber is oxybenzone.
80. The composition of clause 78 wherein the light stabilizer is a hindered amine light stabilizer (HALS).
81. The composition of clause 75 wherein the one or more diluents are selected from the group consisting of isopropyl myristate, dodecyl acetate, mineral oil, citric acid esters, and combinations thereof.
82. The composition of clauses 1-4 which is formulated into a solid or liquid formulation.
83. The composition of clause 82 wherein the liquid formulation is a sprayable or non-sprayable formulation.
84. The composition of clause 82 wherein the solid formulation comprises a thermoplastic matrix or laminate.
85. The composition of clause 84 wherein thermoplastic matrix is selected from the group consisting of polyethylene, polyvinyl chloride, polypropylene, ethylvinyl acetate, polystyrene, rubber, and any blends or combinations thereof.
86. The composition of clauses 1-4 which is formulated into granules, dusts, soluble powders, wettable powders, pastes, emulsifiable concentrates, aerosols, ultra low-volume concentrates, flowable suspensions, oils, sprays, lures, biodegradable flakes, microcapsules, plastic flakes, emulsions, microemulsions, wax emulsions, pellets, natural waxes, synthetic waxes, resins, glues, puffers, membrane systems, film systems, pouches, bubble caps, blocks, monoliths, gels, polyacrylamide plugs, tablets, mesoporous materials, polymer tubes, or any combinations thereof.

### Synergistic Compositions

87. A synergistic composition comprising: at least two isomeric alkatrienyl esters in an amount effective to attract moths of the genus Conopomorpha or male cocoa pod borer Conopomorpha cramerella; or at least two isomeric alkatrienyl alcohols in an amount effective to attract moths of the genus Conopomorpha or male cocoa pod borer Conopomorpha cramerella; or a combination of at least one isomeric alkatrienyl ester and at least one isomeric alkatrienyl alcohol in an amount effective to attract moths of the genus Conopomorpha or male cocoa pod borer Conopomorpha cramerella; wherein the synergistic composition produces, when the moths of the genus Conopomorpha or male cocoa pod borer Conopomorpha cramerella are exposed to the synergistic composition, a combined attractancy effect greater than the sum of the separate attractancy effects from the separate isomeric components of said composition, at comparable concentrations.
88. The synergistic composition of clause 87 wherein moths of the genus Conopomorpha are selected from the group consisting of Conopomorpha cramerella, Conopomorpha sinensis, Conopomorpha antimacha, Conopomorpha chionochtha, Conopomorpha chionosema, Conopomorpha cyanospila, Conopomorpha euphanes, Conopomorpha flueggella, Conopomorpha fustigera, Conopomorpha habrodes, Conopomorpha heliopla, Conopomorpha litchiella, Conopomorpha oceanica, and Conopomorpha zaplaca.
89. The synergistic composition of clause 87 wherein moths of the genus Conopomorpha are selected from the group consisting of Conopomorpha cramerella and Conopomorpha sinensis.
90. The synergistic composition of clause 87 wherein moths of the genus Conopomorpha are the male cocoa pod borer Conopomorpha cramerella.
91. The synergistic composition of clause 87 which is a male cocoa pod borer Conopomorpha cramerella attractant.
92. The synergistic composition of clause 87 wherein the at least two isomeric alkatrienyl esters, or the at least two isomeric alkatrienyl alcohols, or the combination of at least one isomeric alkatrienyl ester and at least one isomeric alkatrienyl alcohol, each comprise a carbon backbone having from about 14 to about 18 carbon atoms, and from about two to about four unsaturated double bonds positioned on the carbon backbone, in which the unsaturated double bonds are conjugated or unconjugated, and have an isomer configuration of cis, trans, or a combination or cis and trans.
93. The synergistic composition of clause 87 further comprising at least one alkyl alcohol, at least one alkyl ester, or a combination thereof.
94. The synergistic composition of clause 93 wherein the at least one alkyl alcohol is hexadecyl alcohol; and the at least one alkyl ester is hexadecyl ester or hexadecyl acetate.
95. The synergistic composition of clauses 1-4 further comprising one or more organic volatile compounds produced and emitted from a fruit and/or plant of the botanical family Sapindaceae, Sterculiaceae, and/or Malvaceae.
96. The synergistic composition of clauses 1-4 further comprising one or more allelochemicals or kairomones.
97. The synergistic composition of clause 96 wherein the one or more allelochemicals or kairomones comprise one or more organic volatile compounds produced and emitted from a fruit and/or plant of the botanical family Sapindaceae, Sterculiaceae, and/or Malvaceae.
98. The synergistic composition of clause 97 wherein the fruit and/or plant is selected from the group consisting of cocoa, rambutan, Fiji Longan, cola, and lychee.
99. The synergistic composition of clause 96 wherein the one or more allelochemicals or kairomones are moths of the genus Conopomorpha attractants, or a male or female cocoa pod borer Conopomorpha cramerella attractant, or a male or female litchi fruit borer Conopomorpha sinensis attractant.
100. The synergistic composition of clauses 87-99 which incorporate embodiments of clauses 5-86.

### Method of Attracting Moths of the Genus Conopomorpha or Male Cocoa Pod Borer Conopomorpha cramerella

101. A method of attracting moths of the genus Conopomorpha or male cocoa pod borer Conopomorpha cramerella, said method comprising treating an object or area with a composition of clauses 1-86, or a synergistic composition of clauses 87-100.
102. The method of clause 101 wherein moths of the genus Conopomorpha are selected from the group consisting of Conopomorpha cramerella, Conopomorpha sinensis, Conopomorpha antimacha, Conopomorpha chionochtha, Conopomorpha chionosema, Conopomorpha cyanospila, Conopomorpha euphanes, Conopomorpha flueggella, Conopomorpha fustigera, Conopomorpha habrodes, Conopomorpha heliopla, Conopomorpha litchiella, Conopomorpha oceanica, and Conopomorpha zaplaca.
103. The method of clause 101 wherein moths of the genus Conopomorpha are selected from the group consisting of Conopomorpha cramerella and Conopomorpha sinensis.
104. The method of clause 101 wherein moths of the genus Conopomorpha are the male cocoa pod borer Conopomorpha cramerella.
105. The method of clause 101 wherein said composition of clauses 1-86, or said synergistic composition of clauses 87-100, is in a trap.

### Method of Monitoring Moths of the Genus Conopomorpha or Cocoa Pod Borer Conopomorpha cramerella

106. A method of monitoring moths of the genus Conopomorpha or cocoa pod borer Conopomorpha cramerella in an area, said method comprising: providing a trap having a lure, wherein the lure comprises the composition of clauses 1-86, or the synergistic composition of clauses 87-100; positioning the trap in the area; and observing moths of the genus Conopomorpha or cocoa pod borer Conopomorpha cramerella captures in the trap over a period of time.
107. The method of clause 106 wherein moths of the genus Conopomorpha are selected from the group consisting of Conopomorpha cramerella, Conopomorpha sinensis, Conopomorpha antimacha, Conopomorpha chionochtha, Conopomorpha chionosema, Conopomorpha cyanospila, Conopomorpha euphanes, Conopomorpha flueggella, Conopomorpha fustigera, Conopomorpha habrodes, Conopomorpha heliopla, Conopomorpha litchiella, Conopomorpha oceanica, and Conopomorpha zaplaca.
108. The method of clause 106 wherein moths of the genus Conopomorpha are selected from the group consisting of Conopomorpha cramerella and Conopomorpha sinensis.
109. The method of clause 106 wherein moths of the genus Conopomorpha are the male cocoa pod borer Conopomorpha cramerella.
110. The method of clause 106 wherein the lure comprises a thermoplastic vial impregnated with the composition of clauses 1-86, or the synergistic composition of clauses 87-100; or a rubber septa impregnated with the composition of clauses 1-86, or the synergistic composition of clauses 87-100.
111. The method of clause 106 wherein the trap is selected from the group consisting of a delta trap, a bucket trap, a water trap, and a funnel trap.
112. The method of clause 106 wherein the trap comprises a delta trap having an adhesive liner.
113. The method of clause 106 wherein the area comprises a cacao orchard, or a rambutan orchard, or a Fiji Longan orchard, or a cola orchard, or a lychee orchard.

### Method of Controlling Moths of the Genus Conopomorpha or Cocoa Pod Borer Conopomorpha cramerella

114. A method of controlling moths of the genus Conopomorpha or cocoa pod borer Conopomorpha cramerella, said method comprising: exposing said moths of the genus Conopomorpha or cocoa pod borer Conopomorpha cramerella to an effective amount of the composition of clauses 1-86, or the synergistic composition of clauses 87-100.
115. The method of clause 114 which is carried out by mass trapping.
116. The method of clause 114 which is carried out by disrupting mating behavior of cocoa pod borer Conopomorpha cramerella.
117. The method of clause 114 which is carried out by releasing the composition of clauses 1-86, or the synergistic composition of clauses 87-100, into an area.
118. The method according to clause 117 wherein the composition is released in cacao fields within the total area, perimeter, border, internal areas, external areas, or any combination thereof.
119. The method of clause 117 which is attract and kill and carried out by combining the composition of clauses 1-86, or the synergistic composition of clauses 87-100, with one or more cocoa pod borer Conopomorpha cramerella insecticides, one or more cocoa pod borer Conopomorpha cramerella biological control agents, or a combination thereof.
120. The method of clause 119 wherein attract and kill is carried out by ingestion or contact; wherein ingestion comprises a bait in association with phagostimulants, adjuvants, and/or insecticides; and wherein contact comprises a tank mix in association with an insecticide spray solution.

### Trap Configured for Capturing Moths of the Genus Conopomorpha or Cocoa Pod Borer Conopomorpha cramerella

121. A trap configured for capturing moths of the genus Conopomorpha or cocoa pod borer Conopomorpha cramerella, said trap having a lure, wherein the lure comprises the composition of clauses 1-86, or the synergistic composition of clauses 87-100.
122. The trap of clause 121 wherein the trap is selected from the group consisting of a delta trap, a bucket trap, a water trap, and a funnel trap.
123. The trap of clause 121 wherein the trap comprises a delta trap.
124. The trap of clause 121 wherein the delta trap has an adhesive liner.
125. The trap of clause 121 wherein the lure comprises a thermoplastic vial impregnated with the composition of clauses 1-86, or the synergistic composition of clauses 87-100; or a rubber septa impregnated with the composition of clauses 1-86, or the synergistic composition of clauses 87-100.

### Substrates

126. A substrate having the composition of clauses 1-86, or the synergistic composition of clauses 87-100, on a surface or impregnated therein.
127. The substrate of clause 126 comprising a trap or a lure.
128. The substrate of clause 127 wherein the trap is selected from the group consisting of a delta trap, a bucket trap, a water trap, and a funnel trap.
129. The substrate of clause 128 wherein the trap is a delta trap.
130. The substrate of clause 127 wherein the lure is a vial, rubber septum, or reservoir container.
131. The substrate of clause 130 wherein the vial is a plastic vial.
132. The substrate of clause 131 wherein the plastic is selected from the group consisting of polyethylene, polyvinyl chloride, polypropylene, ethylvinyl acetate, polystyrene, rubber, and any blends or combinations thereof.
133. The substrate of clause 127 wherein the lure is a rubber septum.
134. The substrate of clause 133 wherein the rubber is selected from the group consisting of natural rubber, halobutyl rubber, gum rubber, and combinations thereof.
135. The substrate of clause 127 wherein the lure is a plastic film or laminate reservoir container.
136. The substrate of clause 135 wherein the plastic film is selected from the group consisting of polyethylene, polyvinyl chloride, polypropylene, ethylvinyl acetate, polystyrene, rubber, and any blends or combinations thereof.

### Processes of Manufacture

137. A process for preparing the composition of clauses 1-86, or the synergistic composition of clauses 87-100, said process comprising:
   (i) providing at least one isomeric alkatrienyl ester; and
blending the at least one isomeric alkatrienyl ester and optional ingredients in an amount effective to attract moths of the genus Conopomorpha or cocoa pod borer Conopomorpha cramerella; or
   (ii) providing at least one isomeric alkatrienyl alcohol; and
blending the at least one isomeric alkatrienyl alcohol and optional ingredients in an amount effective to attract moths of the genus Conopomorpha or cocoa pod borer Conopomorpha cramerella; or
   (iii) providing at least one isomeric alkatrienyl ester;
   providing at least one isomeric alkatrienyl alcohol; and
   blending the at least one isomeric alkatrienyl ester and the at least one isomeric alkatrienyl alcohol in an amount effective to attract moths of the genus Conopomorpha or cocoa pod borer Conopomorpha cramerella.
138. The process of clause 137 wherein moths of the genus Conopomorpha are selected from the group consisting of Conopomorpha cramerella, Conopomorpha sinensis, Conopomorpha antimacha, Conopomorpha chionochtha, Conopomorpha chionosema, Conopomorpha cyanospila, Conopomorpha euphanes, Conopomorpha flueggella, Conopomorpha fustigera, Conopomorpha habrodes, Conopomorpha heliopla, Conopomorpha litchiella, Conopomorpha oceanica, and Conopomorpha zaplaca.
139. The process of clause 137 wherein moths of the genus Conopomorpha are selected from the group consisting of Conopomorpha cramerella and Conopomorpha sinensis.
140. The process of clause 137 wherein moths of the genus Conopomorpha are the male cocoa pod borer Conopomorpha cramerella.
141. The process of clause 137 wherein the at least one isomeric alkatrienyl ester, alone or in combination with the at least one isomeric alkatrienyl alcohol, is selected from the group consisting of (E,E,E)-4,6,10-hexadecatrienyl acetate, (E,E,Z)-4,6,10-hexadecatrienyl acetate, (E,Z,E)-4,6,10-hexadecatrienyl acetate, (Z,E,E)-4,6,10-hexadecatrienyl acetate, (Z,Z,Z)-4,6,10-hexadecatrienyl acetate, (Z,Z,E)-4,6,10-hexadecatrienyl acetate, (Z,E,Z)-4,6,10-hexadecatrienyl acetate, and (E,Z,Z)-4,6,10-hexadecatrienyl acetate.
142. The process of clause 137 wherein the at least one isomeric alkatrienyl alcohol, alone or in combination with the at least one isomeric alkatrienyl ester; is selected from the group consisting of (E,E,E)-4,6,10-hexadecatrienol, (E,E,Z)-4,6,10-hexadecatrienol, (E,Z,E)-4,6,10-hexadecatrienol, (Z,E,E)-4,6,10-hexadecatrienol, (Z,Z,Z)-4,6,10-hexadecatrienol, (Z,Z,E)-4,6,10-hexadecatrienol, (Z,E,Z)-4,6,10-hexadecatrienol, and (E,Z,Z)-4,6,10-hexadecatrienol.
143. The process of clause 137 wherein the at least one isomeric alkatrienyl ester, alone or in combination with the at least one isomeric alkatrienyl alcohol, has from about 0 percent to about 99.9 percent, or from about 5 percent to about 95 percent, or from about 10 percent to about 90 percent, of E,E,E isomers; from about 0 percent to about 99.9 percent, or from about 5 percent to about 95 percent, or from about 10 percent to about 90 percent, of E,E,Z isomers; from about 0 percent to about 99.9 percent, or from about 5 percent to about 95 percent, or from about 10 percent to about 90 percent, of E,Z,E isomers; from about 0 percent to about 99.9 percent, or from about 5 percent to about 95 percent, or from about 10 percent to about 90 percent, of Z,E,E isomers; from about 0 percent to about 99.9 percent, or from about 5 percent to about 95 percent, or from about 10 percent to about 90 percent, of Z,Z,Z isomers; from about 0 percent to about 99.9 percent, or from about 5 percent to about 95 percent, or from about 10 percent to about 90 percent, of Z,Z,E isomers; from about 0 percent to about 99.9 percent, or from about 5 percent to about 95 percent, or from about 10 percent to about 90 percent, of Z,E,Z isomers; and from about 0 percent to about 99.9 percent, or from about 5 percent to about 95 percent, or from about 10 percent to about 90 percent, of E,Z,Z isomers; based on the total isomers in the composition.
144. The process of clause 137 wherein the at least one isomeric alkatrienyl alcohol, alone or in combination with the at least one isomeric alkatrienyl ester, has from about 0 percent to about 99.9 percent, or from about 0.01 percent to about 95 percent, or from about 0.1 percent to about 90 percent, of E,E,E isomers; from about 0 percent to about 99.9 percent, or from about 0.05 percent to about 95 percent, or from about 0.1 percent to about 90 percent, of E,E,Z isomers; from about 0 percent to about 99.9 percent, or from about 0.01 percent to about 95 percent, or from about 0.1 percent to about 90 percent, of E,Z,E isomers; from about 0 percent to about 99.9 percent, or from about 0.01 percent to about 95 percent, or from about 0.1 percent to about 90 percent, of Z,E,E isomers; from about 0 percent to about 99.9 percent, or from about 0.01 percent to about 95 percent, or from about 0.1 percent to about 90 percent, of Z,Z,Z isomers; from about 0 percent to about 99.9 percent, or from about 0.01 percent to about 95 percent, or from about 0.1 percent to about 90 percent, of Z,Z,E isomers; from about 0 percent to about 99.9 percent, or from about 0.01 percent to about 95 percent, or from about 0.1 percent to about 90 percent, of Z,E,Z isomers; and from about 0 percent to about 99.9 percent, or from about 0.05 percent to about 95 percent, or from about 0.1 percent to about 90 percent, of E,Z,Z isomers; based on the total isomers in the composition.
145. A process for preparing the composition of clause 1, or the synergistic composition of clause 87, said process comprising:
providing a synthetic pheromone of cocoa pod borer Conopomorpha cramerella impregnated in, or on a surface of, a substrate;
subjecting the synthetic pheromone and substrate to reaction conditions sufficient to form the composition of clause 1, or the synergistic composition of clause 87.
146. The process of clause 145 wherein the substrate is a trap or a lure.
147. The process of clause 145 wherein the trap is a delta trap; and wherein the lure is a vial, rubber septum, or reservoir container.
148. The process of clause 147 wherein the vial is a plastic vial; wherein the plastic is selected from the group consisting of polyethylene, polyvinyl chloride, polypropylene, ethylvinyl acetate, polystyrene, rubber, and any blends or combinations thereof.
149. The process of clause 147 wherein the lure is a rubber septum; wherein the rubber is selected from the group consisting of natural rubber, halobutyl rubber, gum rubber, and combinations thereof.
150. The process of clause 147 wherein the lure is a plastic film or laminate reservoir container; wherein the plastic film is selected from the group consisting of polyethylene, polyvinyl chloride, polypropylene, ethylvinyl acetate, polystyrene, rubber, and any blends or combinations thereof.
151. The process of clause 145 wherein the synthetic pheromone comprises at least two isomeric alkatrienyl esters and at least two isomeric alkatrienyl alcohols.
152. The process of clause 145 wherein the reaction conditions comprise a temperature from about 25° C. to about 50° C., a pressure from about 1000 to about 1025 hectopascal (hPa), a relative humidity ranging between about 70% and about 90%, and a reaction time from about 1 minute or less to about 24 hours or longer.
153. A process for preparing the composition of clause 1, or the synergistic composition of clause 87, said process comprising:
providing a synthetic pheromone of cocoa pod borer Conopomorpha cramerella;
reacting the synthetic pheromone in the presence of a catalyst and under reaction conditions sufficient to form the composition of clause 1, or the synergistic composition of clause 87, before or after inclusion in a controlled release formulation.
154. The process of clause 153 wherein the synthetic pheromone and the catalyst are impregnated in, or on a surface of, a substrate.
155. The process of clause 154 wherein the substrate is a trap or a lure.
156. The process of clause 155 wherein the trap is a delta trap; and wherein the lure is a vial, rubber septum, or reservoir container.
157. The process of clause 156 wherein the vial is a plastic vial; wherein the plastic is selected from the group consisting of polyethylene, polyvinyl chloride, polypropylene, ethylvinyl acetate, polystyrene, rubber, and any blends or combinations thereof.
158. The process of clause 156 wherein the lure is a rubber septum; wherein the rubber is selected from the group consisting of natural rubber, halobutyl rubber, gum rubber, and combinations thereof.
159. The process of clause 156 wherein the lure is a plastic film or laminate reservoir container; wherein the plastic film is selected from the group consisting of polyethylene, polyvinyl chloride, polypropylene, ethylvinyl acetate, polystyrene, rubber, and any blends or combinations thereof.
160. The process of clause 153 wherein the synthetic pheromone comprises at least two isomeric alkatrienyl esters and at least two isomeric alkatrienyl alcohols.
161. The process of clause 153 wherein the catalyst is an olefin isomerization catalyst.
162. The process of clause 161 wherein the olefin isomerization catalyst is sulfur or a thiol.
163. The process of clause 153 wherein the reaction conditions comprise a temperature from about 25° C. to about 50° C., a pressure from about 1000 to about 1025 hectopascal (hPa), a relative humidity ranging between about 70% and about 90%, and a reaction time from about 1 minute or less to about 24 hours or longer.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A composition comprising at least one isomeric alkatrienyl ester, wherein the at least one isomeric alkatrienyl ester comprises (E,Z,Z)-4,6,10-hexadecatrienyl acetate and (Z,E,Z)-4,6,10-hexadecatrienyl acetate, in an amount effective to attract moths of the genus Conopomorpha or cocoa pod borer Conopomorpha cramerella.

2. The composition of claim 1, further comprising at least one isomeric alkatrienyl alcohol.

3. The composition of claim 2, wherein the at least one isomeric alkatrienyl alcohol comprises (E,Z,Z)-4,6,10-hexadecatrienol and (Z,E,Z)-4,6,10-hexadecatrienol.

4. The composition of claim 3, further comprising at least one isomeric alkatrienyl ester selected from the group consisting of: (E,E,E)-4,6,10-hexadecatrienyl acetate; (E,E,Z)-4,6,10-hexadecatrienyl acetate; (E,Z,E)-4,6,10-hexadecatrienyl acetate; (Z,E,E)-4,6,10-hexadecatrienyl acetate; (Z,Z,Z)-4,6,10-hexadecatrienyl acetate; and (Z,Z,E)-4,6,10-hexadecatrienyl acetate.

5. The composition of claim 4, further comprising at least one isomeric alkatrienyl alcohol selected from the group consisting of (E,E,E)-4,6,10-hexadecatrienol; (E,E,Z)-4,6,10-hexadecatrienol;
(E,Z,E)-4,6,10-hexadecatrienol; (Z,E,E)-4,6,10-hexadecatrienol;
(Z,Z,Z)-4,6,10-hexadecatrienol; and (Z,Z,E)-4,6,10-hexadecatrienol.

6. The composition of claim 5 further comprising at least one alkyl alcohol and at least one alkyl ester, wherein the at least one alkyl alcohol comprises hexadecyl alcohol and the at least one alkyl ester comprises hexadecyl acetate.

7. The composition of claim 6 further comprising at least one isomeric alkatrienyl ester selected from the group consisting of isomeric tetradecatrienyl formates, isomeric hexadecatrienyl formates, other isomeric hexadecatrienyl acetates, isomeric hexadecatrienyl propionates, isomeric hexadecatrienyl butyrates, isomeric hexadecatrienyl isobutyrates, isomeric hexadecatrienyl valerates, isomeric hexadecatrienyl isovalerates, isomeric hexadecatrienyl alpha methyl butyrates, isomeric hexadecatrienyl hexanoates, isomeric hexadecatrienyl heptanoates, and isomeric hexadecatrienyl octanoates.

8. The composition of claim 1 wherein the at least one isomeric alkatrienyl ester is present in an amount from about 0.1 weight percent to about 99.9 weight percent, or from about 5 weight percent to about 95 weight percent, or from about 10 weight percent to about 90 weight percent, based on the total weight of the composition.

9. The composition of claim 2 wherein the at least one isomeric alkatrienyl alcohol is present in an amount from about 0.1 weight percent to about 99.9 weight percent, or from about 5 weight percent to about 95 weight percent, or from about 10 weight percent to about 90 weight percent, based on the total weight of the composition.

10. The composition of claim 7 which is formulated into a solid or liquid formulation.

11. The composition of claim 7 which is formulated into granules, dusts, soluble powders, wettable powders, pastes, emulsifiable concentrates, aerosols, ultra low-volume concentrates, flowable suspensions, oils, sprays, lures, biodegradable flakes, microcapsules, plastic flakes, emulsions, microemulsions, wax emulsions, pellets, natural waxes, synthetic waxes, resins, glues, puffers, membrane systems, film systems, plastic film laminate reservoir containers, plastic vials, rubber septum, impregnated elastomers, pouches, bubble caps, blocks, monoliths, gels, polyacrylamide plugs, tablets, mesoporous materials, polymer tubes, or any combinations thereof.

12. The composition of claim 7 further comprising one or more antioxidants, one or more diluents, one or more ultraviolet light stabilizers, or combinations thereof.

13. The composition of claim 7 further comprising one or more insecticides, one or more allelochemicals or kairomones, or any combination thereof.

14. A synergistic composition comprising at least one isomeric alkatrienyl ester in an amount effective to attract moths of the genus Conopomorpha or cocoa pod borer Conopomorpha cramerella; and at least one allelochemical or kairomone in an amount effective to attract moths of the genus Conopomorpha or cocoa pod borer Conopomorpha cramerella; wherein the synergistic composition produces, when the moths of the genus Conopomorpha or cocoa pod borer Conopomorpha cramerella are exposed to the synergistic composition, a combined attractancy effect greater than the sum of the separate attractancy effects from the separate alkatrienyl ester and allelochemical or kairomone components of said composition, at comparable concentrations.

15. The synergistic composition of claim 14 wherein the at least one isomeric alkatrienyl ester comprises (E,Z,Z)-4,6,10-hexadecatrienyl acetate and (Z,E,Z)-4,6,10-hexadecatrienyl acetate, and the at least one allelochemical or kairomone comprises one or more organic volatile compounds produced and emitted from a fruit and/or plant of the botanical family Sapindaceae, Sterculiaceae, and/or Malvaceae.

16. A method of attracting, monitoring, or controlling moths of the genus Conopomorpha or male cocoa pod borer Conopomorpha cramerella, said method comprising treating an object or area with a composition of claim 7, in an amount effective to attract moths of the genus Conopomorpha or male cocoa pod borer Conopomorpha cramerella; or exposing said moths of the genus Conopomorpha or cocoa pod borer Conopomorpha cramerella to an effective amount of the composition of claim 7.

17. The method of claim 16 wherein the area comprises a cacao plantation, or orchard, or a rambutan orchard, or a Fiji Longan orchard, or a cola orchard, or a lychee orchard.

18. The method of claim 16 which is carried out by mass trapping, or by disrupting mating behavior, or by releasing the composition into an area, or by attract and kill carried out by combining the composition with one or more cocoa pod borer Conopomorpha cramerella insecticides, one or more cocoa pod borer Conopomorpha cramerella biological control agents, or a combination thereof.

19. The method of claim 16 wherein moths of the genus Conopomorpha are selected from the group consisting of Conopomorpha cramerella, Conopomorpha sinensis, Conopomorpha antimacha, Conopomorpha chionochtha, Conopomorpha chionosema, Conopomorpha cyanospila, Conopomorpha euphanes, Conopomorpha flueggella, Conopomorpha fustigera, Conopomorpha habrodes, Conopomorpha heliopla, Conopomorpha litchiella, Conopomorpha oceanica, and Conopomorpha zaplaca.

20. A process comprising:
providing a synthetic pheromone of cocoa pod borer Conopomorpha cramerella; and
reacting the synthetic pheromone in the presence of an isomerization catalyst comprising sulfur or a thiol, and under reaction conditions sufficient to form the composition of claim 7 before or after inclusion in a controlled release formulation.
